(19) United States
(12) Patent Application Publication
(10) Pub. No.: US 2026/0064559 A1
(43) Pub. Date: Mar. 5, 2026

(54) SYSTEMS AND METHODS FOR PERFORMANCE MODELING

(71) Applicant: Wells Fargo Bank, N.A., San Francisco, CA (US)

(72) Inventors: Justin Cullen, San Francisco, CA (US); Frank Fehrenbach, New York, NY (US)

(73) Assignee: Wells Fargo Bank, N.A., San Francisco, CA (US)

(21) Appl. No.: 18/817,637

(22) Filed: Aug. 28, 2024

(51) Int. Cl. G06F 11/34

(52) U.S. Cl. CPC G06F 11/3447

(57) ABSTRACT

Various systems and methods are disclosed relating to modeling performance of entities using one or more artificial intelligence (AI) models. A data processing system includes processing circuits that can be configured to receive an input corresponding to an entity to model and access one or more data sources corresponding to the entity. The processing circuits can be further configured to identify a modeling dataset and generate, for one or more AI models, a prompt based on the modeling dataset, entity data of the entity, and/or one or more benchmarks and apply the modeling dataset and the prompt as input to the one or more AI models to cause the one or more AI models to generate an output regarding one or more performance metrics of the entity. The processing circuits can be further configured to generate the one or more performance indicators and transmit the one or more performance indicators.

### TECHNICAL FIELD

The present implementations generally relates to machine learning, generative artificial intelligence (AI), and/or modeling systems. More particularly, the present systems and methods relate to using a modeling system to process data items to generate performance indicators and recommendations.

### BACKGROUND

In a computer networked environment, users and entities like individuals or companies, may desire to model data to generate and assess performance. This process can involve the integration of diverse data sources and the application of analytical techniques. The ability to analyze data dynamically and model various metrics is important for generating performance assessments and indicators.

### SUMMARY

Some implementations relate to a method for modeling performance of entities using one or more artificial intelligence (AI) models. The method can include receiving, by one or more processing circuits, an input corresponding to an entity to model. The method can further include, responsive to the input, accessing, by the one or more processing circuits via one or more data channels, one or more data sources corresponding to the entity. The method can further include identifying, by the one or more processing circuits based on the accessing of the one or more data sources via the one or more data channels, a modeling dataset. The method can further include generating, by the one or more processing circuits for the one or more AI models, a prompt based on (i) the modeling dataset, (ii) entity data of the entity, and (iii) one or more performance benchmarks. In some implementations, generating the prompt includes mapping one or more associations corresponding to the modeling dataset and one or more performance parameters of one or more performance indicators. The method can further include applying, by the one or more processing circuits, the modeling dataset and the prompt as input to the one or more AI models to cause the one or more AI models to generate an output regarding one or more performance metrics of the entity to correspond to the one or more performance parameters, the output including one or more performance product recommendations based on the one or more performance metrics. The method can further include generating, by the one or more processing circuits using a performance indicator framework, the one or more performance indicators of the entity based on the one or more performance metrics. The method can further include transmitting, by the one or more processing circuits to a user computing system, the one or more performance indicators and the one or more performance product recommendations, the one or more performance indicators includes one or more AI responses annotating the one or more performance indicators for review.

In some implementations, the modeling dataset includes a plurality of unstructured data items corresponding to non-relational data generated by the one or more data sources, and wherein applying the modeling dataset and the prompt as the input to the one or more AI models includes transforming, by the one or more processing circuits, the plurality of unstructured data items into a plurality of feature vectors. The method can further include normalizing, by the one or more processing circuits, the plurality of feature vectors to a scale. The method can further include inputting, by the one or more processing circuits, the normalized plurality of feature vectors into the one or more AI models to perform predictive and pattern recognition to cause the one or more AI models to generate the output.

In some implementations, the one or more AI models include a generative AI model, and wherein the generative AI model include at least one of (i) a supervised learning model trained on labeled performance indicators of a plurality of historical performance indicators or (ii) an unsupervised learning model trained on unlabeled performance indicators of the plurality of historical performance indicators.

In some implementations, the generative AI model implements reinforcement learning. In some implementations, the reinforcement learning includes updating the generative AI model based upon receiving feedback on the output and the one or more performance indicators generated from the one or more performance metrics, the feedback corresponding to at least one user interaction with a user interface.

In some implementations, determining the one or more performance benchmarks can include collecting, by the one or more processing circuits, historical performance data from a plurality of entities. In some implementations, determining the one or more performance benchmarks can include modeling, by the one or more processing circuits using the one or more AI models, the historical performance data to generate one or more standard performance metrics. In some implementations, determining the one or more performance benchmarks can include determining, by the one or more processing circuits, the one or more performance benchmarks based on the one or more standard performance metrics.

In some implementations, the one or more AI responses annotating the one or more performance indicators include metadata annotations corresponding to data provenance, model confidence levels, and feature importance scores.

In some implementations, the input is received (i) periodically according to a predefined schedule, (ii) on-demand via a user interface, or (iii) based on a detected event corresponding to the entity.

In some implementations, the method can further include receiving, by the one or more processing circuits, a request from a third-party computing system to re-model the entity or detecting, by the one or more processing circuits, an update of an entry in the one or more data sources to re-model the entity.

In some implementations, the one or more performance product recommendations include at least one of (i) a performance update including an update to a term or condition of the one or more performance indicators based on the one or more performance metrics, or (ii) a product update including a new performance indicator based on the one or more performance metrics

In some implementations, the method can further include populating the modeling dataset by accessing, by the one or more processing circuits, external data from one or more external computing systems. In some implementations, the method can further include accessing, by the one or more processing circuits, internal data from one or more internal computing systems. In some implementations, the external data includes at least one of third-party datasets, comparative performance metrics, environmental factors, or demographic information and the internal data includes at least one of proprietary datasets, exchange records, operational data, or internal metrics.

Some implementations relate to a system for modeling performance of entities using one or more artificial intelligence (AI) models. The system can include a data processing system including one or more processing circuits that can be configured to receive an input corresponding to an entity to model. The one or more processing circuits can be further configured to, responsive to the input, access, via one or more data channels, one or more data sources corresponding to the entity. The one or more processing circuits can be further configured to identify, based on the accessing of the one or more data sources via one or more data channels, a modeling dataset. The one or more processing circuits can be further configured to generate, for one or more artificial intelligence (AI) models, a prompt based on (i) the modeling dataset, (ii) entity data of the entity, and (iii) one or more performance benchmarks. In some implementations, generating the prompt includes mapping one or more associations corresponding to the modeling dataset and one or more performance parameters of one or more performance indicators. The one or more processing circuits can be further configured to apply the modeling dataset and the prompt as input to the one or more AI models to cause the one or more AI models to generate an output regarding one or more performance metrics of the entity to correspond to the one or more performance parameters, the output including one or more performance product recommendations based on the one or more performance metrics. The one or more processing circuits can be further configured to generate, using a performance indicator framework, the one or more performance indicators of the entity based on the one or more performance metrics. The one or more processing circuits can be further configured to transmit, to a user computing system, the one or more performance indicators and the one or more performance product recommendations, the one or more performance indicators includes one or more AI responses annotating the one or more performance indicators for review.

some implementations, the modeling dataset includes a plurality of unstructured data items corresponding to non-relational data generated by the one or more data sources, and wherein applying the modeling dataset and the prompt as the input to the one or more AI models includes transforming the plurality of unstructured data items into a plurality of feature vectors, normalizing the plurality of feature vectors to a scale, and inputting the normalized plurality of feature vectors into the one or more AI models to perform predictive and pattern recognition to cause the one or more AI models to generate the output.

In some implementations, the one or more AI models include a generative AI model, and wherein the generative AI model include at least one of (i) a supervised learning model trained on labeled performance indicators of a plurality of historical performance indicators or (ii) an unsupervised learning model trained on unlabeled performance indicators of the plurality of historical performance indicators.

In some implementations, the generative AI model implements reinforcement learning. In some implementations, the reinforcement learning includes updating the generative AI model based upon receiving feedback on the output and the one or more performance indicators generated from the one or more performance metrics, the feedback corresponding to at least one user interaction with a user interface.

In some implementations, further including determining the one or more performance benchmarks by collecting historical performance data from a plurality of entities, modeling, using the one or more AI models, the historical performance data to generate one or more standard performance metrics, and determining the one or more performance benchmarks based on the one or more standard performance metrics.

In some implementations, the one or more AI responses annotating the one or more performance indicators include metadata annotations corresponding to data provenance, model confidence levels, and feature importance scores.

In some implementations, the input is received (i) periodically according to a predefined schedule, (ii) on-demand via a user interface, or (iii) based on a detected event corresponding to the entity.

In some implementations, the one or more processing circuits can be further configured to receive a request from a third-party computing system to re-model the entity or detect an update of an entry in the one or more data sources to re-model the entity.

In some implementations, the one or more performance product recommendations include at least one of (i) a performance update including an update to a term or condition of the one or more performance indicators based on the one or more performance metrics, or (ii) a product update including a new performance indicator based on the one or more performance metrics

Some implementations relate to a method for modeling performance of entities using one or more artificial intelligence (AI) models. The method can include receiving, by one or more processing circuits, an input corresponding to an entity to model. The method can further include, responsive to the input, accessing, by the one or more processing circuits via one or more data channels, one or more data sources corresponding to the entity. The method can further include identifying, by the one or more processing circuits based on the accessing of the one or more data sources via the one or more data channels, a modeling dataset. The method can further include applying, by the one or more processing circuits, the (i) the modeling dataset, (ii) entity data of the entity, and (iii) one or more performance benchmarks as input to one or more AI models to cause one or more AI models to generate an output regarding one or more performance metrics of the entity to correspond to one or more performance parameters. The method can further include generating, by the one or more processing circuits using a performance indicator framework, one or more performance indicators of the entity based on the one or more performance metrics. The method can further include transmitting, by the one or more processing circuits to a user computing system, the one or more performance indicators including one or more AI responses annotating the one or more performance indicators for review.

Numerous specific details are provided to impart a thorough understanding of implementations of the subject matter of the present disclosure. The described features of the subject matter of the present disclosure can be combined in any suitable manner in one or more embodiments and/or implementations. In this regard, one or more features of an aspect of the implementations can be combined with one or more features of a different aspect of the implementations. Moreover, additional features can be recognized in certain embodiments and/or implementations that cannot be present in all embodiments or implementations.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers indicate identical, functionally similar, and/or structurally similar elements.

FIG. 1 depicts an example modeling system, according to some implementations.

FIG. 2 depicts a block diagram illustrating an example computing system for use in the various implementations described herein.

FIG. 3 depicts an example data flow of a computer-implemented or computer-based process of modeling performance of an entity, according to some implementations.

FIG. 4 depicts a method to model performance of entities using one or more AI models, according to some implementations.

It will be recognized that some or all of the FIGS. are schematic representations for purposes of illustration. The FIGS. are provided for the purpose of illustrating one or more implementations with the explicit understanding that they will not be used to limited the scope of the meaning the claims.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the FIGS. and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, any term in the specification or claims should not be ascribed an uncommon or special meaning unless explicitly set forth as such. Further, the present implementations encompass present and future known equivalents to the known components referred to herein by way of illustration.

This disclosure relates to systems, computer-readable media, and methods for generating dynamic performance assessments and cybersecurity evaluations using artificial intelligence (AI) models. As described herein, the disclosed systems and methods can integrate data from multiple sources, analyze it using AI, provide real-time performance metrics, indicators, and/or recommendations. The technological improvements can include, for example, the implementations of AI-driven data analysis, dynamic benchmarking, and/or automated performance evaluations to improve the accuracy and efficiency of performance assessments (or indicators) and cybersecurity protocols.

Typically, the process of generating performance assessments and conducting cybersecurity evaluations involves multiple systems that operate independently, leading to inefficiencies and inconsistencies in data processing. These processes are particularly challenging at large scales where performance and security data need to be accurately integrated and analyzed across different departments or entities. Manual approaches also generally lack real-time monitoring and predictive capabilities, making them unsuitable for today's dynamic performance and security environments. In response, some systems employ centralized databases, which can create single points of failure and bottlenecks. That is, traditional systems facilitate the storage and retrieval of data within isolated systems, leading to potential discrepancies and inefficiencies. This indirect approach can lead to delays in assessments, dependency on manual oversight, and/or increased risk of data inaccuracies.

The AI-based systems and methods described herein, in contrast, provide secure and verifiable data analysis across integrated data sources, thereby eliminating the need for centralized databases and the associated inefficiencies. By using AI-driven modeling and dynamic data integration that automatically updates based on predefined conditions such as performance metrics or security events, the systems and methods can ensure the accuracy and timeliness of performance evaluations in real-time or near real-time. Additionally, to address the technical problems, the described systems and methods employ an improved AI-based approach that integrates dynamic benchmarking for automating data evaluations. These AI models can be designed to update automatically when predefined conditions, such as performance changes or security incidents, are met. This implementation improves efficiency by minimizing manual interventions and errors, providing accurate and actionable performance metrics across various data sources.

The described technical improvement to evaluate and update performance metrics upon satisfying the predefined conditions provides a technical advantage by improving the speed and efficiency of generating performance assessments and cybersecurity evaluations. It also reduces operational overhead and enhances data integrity, ensuring accurate and consistent evaluations across multiple systems. Furthermore, by maintaining a comprehensive record of performance and security metrics on the integrated platform, the systems and methods provide improved auditability and compliance, aspects that are less efficiently handled by traditional centralized systems. Moreover, the architecture supports improved monitoring and predictive capabilities, providing real-time tracking of operational health and security posture. Furthermore, the systems and methods described herein can dynamically handle multiple types of data elements through a unified platform, reducing the complexity and computational overhead associated with traditional assessment processes.

The performance indicators generated by the AI models provide structured analytical documents or tools that capture various dimensions of operational and strategic performance of an entity. These documents can include insights derived from performance metrics such as efficiency metrics, compliance scores, risk assessments, and/or other quantifiable measures that reflect the overall performance of the entity. Additionally, a technical problem addressed by the described systems and methods is the challenge of integrating and processing heterogeneous data sources in real-time. Traditional systems exhibit limitations with data heterogeneity, where data from different sources can have varying formats, structures, and/or quality levels. This discrepancy leads to increased complexity in data processing and limits the ability to perform timely and accurate assessments. The AI-based approach described herein employs data normalization and feature extraction techniques, facilitating integration and analysis of diverse data types. This technical solution enhances the technical capabilities of the systems to generate improved performance metrics and indicators, thereby improving overall system reliability and effectiveness.

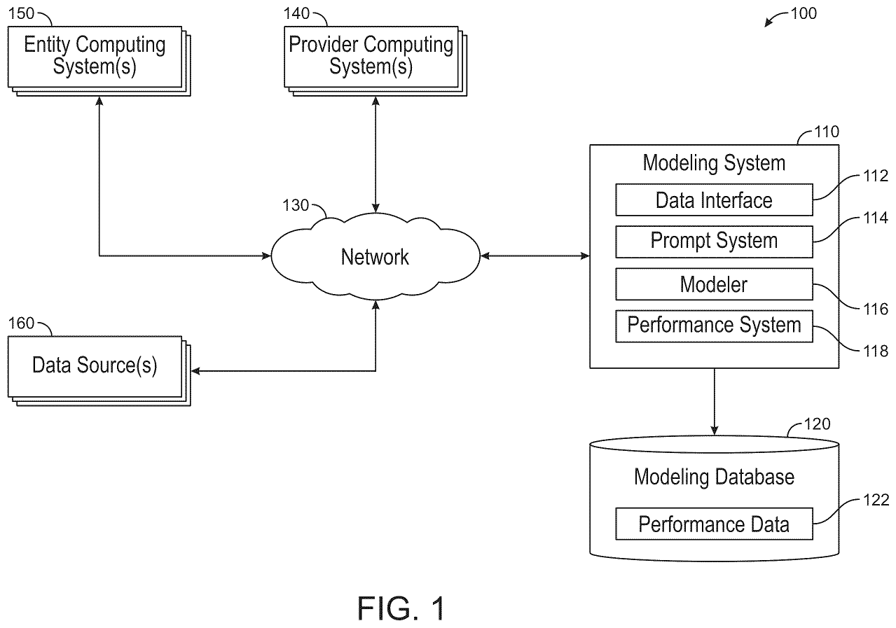

Referring to FIG. 1, a block diagram of an example modeling system 110 in a computing system 100 is shown, according to some implementations. The modeling system 110 can have a data interface 112, prompt system 114, modeler 116, and/or performance system 118. The computing system 100 can also include a modeling database 120 having performance data 122. The computing system 100 can also include a provider computing system 140, an entity computing system 150, and/or data sources 160. The components of the computing system 100 can be connected, or in wired or wireless communication, via a network 130. It should be noted that the number and type of components shown is merely illustrative and, in some implementations, implementations of the computing system 100 can have additional, fewer, and/or different components than those illustrated in FIG. 1 including those mentioned elsewhere herein.

The components of the computing system 100 can be connected, or in communication, via a network 130. Network 130 can include computer networks such as the Internet, local, wide, metro or other area networks, intranets, satellite networks, other computer networks such as voice or data mobile phone communication networks, combinations thereof, or any other type of electronic communications network. Network 130 can include or constitute a display network. In some implementations, network 130 facilitates secure communication between components of computing system 100. As a non-limiting example, network 130 can implement transport layer security (TLS), secure sockets layer (SSL), hypertext transfer protocol secure (HTTPS), and/or any other secure communication protocol. It should be noted that the number and type of components shown are merely illustrative, and in some implementations the computing system 100 can have additional, fewer, and/or different components than those illustrated in FIG. 1.

The network 130 can facilitate communication between various nodes, such as the modeling system 110, the provider computing system 140, the entity computing system 150, the data sources 160, and/or the modeling database 120. In some implementations, data flows through the network 130 from a source node to a destination node as a flow of data packets, e.g., in the form of data packets in accordance with the Open Systems Interconnection (OSI) layers. A flow of packets can use, for example, an OSI layer-4 transport protocol such as the User Datagram Protocol (UDP), the Transmission Control Protocol (TCP), or the Stream Control Transmission Protocol (SCTP), transmitted via the network 130 layered over an OSI layer-3 network protocol such as Internet Protocol (IP), e.g., IPv4 or IPv6. The network 130 can be composed of various network devices (nodes) that are communicatively linked to form one or more data communication paths between participating devices. Each networked device includes at least one network interface for receiving and/or transmitting data, typically as one or more data packets. An illustrative network 130 is the Internet; however, other networks can be used. The network 130 can be an autonomous system (AS), i.e., a network that is operated under a consistent unified routing policy (or at least appears to be from outside the AS network) and is generally managed by a single administrative entity (e.g., a system operator, administrator, or administrative group).

Generally, the modeling system 110, provider computing system 140, entity computing system 150, and modeling database 120 can include one or more logic devices, which can be one or more computing devices equipped with one or more processing circuits that execute instructions stored in a memory device to perform various operations. The processing circuit can be made up of various components such as a microprocessor, an ASIC, or an FPGA, and the memory device can be any type of storage or transmission device capable of providing program instructions. The instructions can include code from various programming languages commonly used in the industry, such as high-level programming languages, web development languages, and system programming languages. The modeling system 110, provider computing system 140, entity computing system 150, and data sources 160 can also include one or more databases for storing data, such as modeling database 120, that receive and provide data to other systems and devices on the network 130.

The systems or devices in computing system 100 can include one or more processors, memories, network interfaces (sometimes referred to herein as a “network circuit”) and user interfaces. The memory can store programming logic that, when executed by the processor controls the operation of the corresponding computing system or device. The memory can also store data in databases. The network interfaces can facilitate wireless communications or otherwise with the computing systems and devices. The various components of devices in computing system 100 can be implemented via hardware (e.g., circuitry), software (e.g., executable code), or any combination thereof. Devices, systems, and components in FIG. 1 can be added, deleted, integrated, separated, and/or rearranged in various implementations of the disclosure.

As will be discussed in greater detail below, the modeling system 110 can be configured to receive an input corresponding to an entity to model. For example, the input can be received periodically according to a predefined schedule. In another example, the input can be received on-demand via a user interface (e.g., from a provider computing system 140). In yet another example, the input can be received based on a detected event corresponding to the entity. The modeling system 110 can also be configured to access, via one or more data channels, one or more data sources corresponding to an entity. For example, the data sources can be external computing systems external to a provider environment or internal computing systems internal to the provider environment. The modeling system 110 can also be configured to identify a modeling dataset. The modeling dataset can be identified based on the accessing of the one or more data sources via one or more data channels. For example, the modeling dataset can be an aggregation or grouping of data collected from various sources.

The modeling system 110 can also be configured to generate a prompt based on the modeling dataset, entity data of the entity, and/or one or more performance benchmarks for one or more artificial intelligence (AI) models. For instance, generating the prompt can include mapping one or more associations corresponding to the modeling dataset and one or more performance parameters of one or more performance indicators. The entity data can include general data about the entity such as type of business, address, business name, industry classification, size of entity, or any relevant entity attribute. Additionally, the performance benchmarks can be templates or standardized points of reference used to generate a prompt that can guide the AI model in evaluating the modeling dataset and entity data. For example, performance benchmarks can include operational efficiency metrics, quality assurance scores, environmental compliance ratings, safety incident rates, customer satisfaction indices, project completion times, supply chain reliability metrics, credit risk scores, cybersecurity risk assessments, employee performance ratings, product defect rates, financial ratios, regulatory compliance levels, loan repayment histories, energy consumption rates, or any standardized metrics used by providers or other third-parties to evaluate performance. In some implementations, mapping associations can include linking specific data points from the modeling dataset to the criteria (e.g., performance parameters) used for evaluation to issue the performance indicator. The performance parameter can be component or business indicators, efficiency metrics, and/or other relevant criteria that determine the overall performance of an entity. The performance indicators can represent a structured analytical construct or data structure that can include various dimensions of operational and strategic performance of an entity. For example, the performance indicator can be a cybersecurity assessment, a car safety evaluation, an environmental impact analysis, a project management review, a quality control summary, a customer satisfaction report, a compliance audit, a credit memorandum (or credit memo), a supply chain performance analysis, an employee performance evaluation, or any structured analytical construct.

The modeling system 110 can also be configured to apply the modeling dataset and the prompt as input to the one or more AI models to cause the one or more AI models to generate an output regarding one or more performance metrics of the entity to correspond to the one or more performance parameters. For example, the output can include one or more performance product recommendations based on the one or more performance metrics. That is, the performance metrics can be quantitative measures used to evaluate performance of an entity evaluated against the predefined criteria or standards to issue a performance indicator. Additionally, the performance product recommendations can be cybersecurity solutions, car safety systems, environmental protection plans, project management tools, quality assurance programs, customer service solutions, compliance protocols, risk management services, supply chain enhancements, employee development programs, technology upgrades, operational efficiency strategies, or any alternative product or service recommendation based on the performance indicators.

The modeling system 110 can also be configured to generate, using a performance indicator framework, the one or more performance indicators of the entity based on the one or more performance metrics. For example, the performance indicator framework can be predefined templates or structures used to generate the performance indicator that incorporates the various performance metrics. The modeling system 110 can also be configured to transmit the one or more performance indicators and the one or more performance product recommendations to a user computing system (e.g., provider computing system 140). For example, the one or more performance indicators can include one or more AI responses annotating the one or more performance indicators for review. In this example, the AI responses can be metadata annotations corresponding to data provenance (e.g. origin and history the data used), model confidence levels (e.g., prediction confidence of the models output), and/or feature importance scores (e.g., how data points contributes to the output generated by the AI model).

Referring to performance benchmarks generally, performance benchmarks can be standardized points of reference (e.g., standard performance benchmarks) used to evaluate the performance of an entity. That is, performance benchmarks can provide comparative metrics against which the performance of the entity is measured. In some implementations, performance benchmarks can include predefined standards or metrics relevant to the industry or domain. For example, performance benchmarks can include key performance indicators (KPIs), industry averages, credit risk scores, and/or regulatory compliance metrics (e.g., environmental regulations, safety standards). In another example, performance benchmarks can be derived from historical data (e.g., past performance metrics), financial ratios, and/or market analysis. In some implementations, the modeling system 110 can generate or modify performance benchmarks (e.g., standard performance benchmarks).

Referring to performance parameters generally, performance parameters can be criteria or standards used to assess the performance metrics of an entity. That is, performance parameters can define acceptable ranges or thresholds for various performance metrics. In some implementations, performance parameters can be customized based on the operational goals of the entity. For example, performance parameters can include target production rates (e.g., units produced per hour), quality control limits (e.g., defect rates), efficiency benchmarks, and/or creditworthiness criteria. In another example, performance parameters can be established based on risk assessments and objectives (e.g., achieving specific sustainability targets).

Referring to mapping one or more associations generally, mapping can include linking data points from the modeling dataset to the performance parameters. That is, mapping associations can create relationships between the raw data and the criteria used for evaluation. In some implementations, mapping can include using machine learning (ML) algorithms to identify correlations. For example, mapping associations can include linking sales data to market trends (e.g., seasonal sales patterns), and/or financial data to credit risk scores. In another example, mapping can include connecting operational metrics to performance outcomes (e.g., linking machine uptime to production efficiency).

Referring to performance indicators generally, performance indicators can be structured analytical constructs used to evaluate the performance of an entity. That is, performance indicators can provide a view of various performance aspects. In some implementations, performance indicators can be tailored to operational areas. For example, performance indicators can include operational efficiency reports (e.g., productivity analysis), compliance audits (e.g., adherence to safety protocols), customer satisfaction surveys, and/or credit memoranda. In another example, performance indicators can be used to generate assessments like environmental impact analyses (e.g., carbon footprint calculations) or project evaluations.

Referring to performance metrics generally, performance metrics can be quantitative measures used to assess the performance of an entity. That is, performance metrics can provide data points that reflect the operational and strategic performance of an entity. In some implementations, performance metrics can include various quantitative measures. For example, performance metrics can include production volumes (e.g., total output per month), error rates (e.g., defect counts), resource utilization, and/or credit scores. In another example, performance metrics can encompass customer feedback scores (e.g., satisfaction ratings) and time-to-market data.

Referring to performance product recommendations generally, performance product recommendations can be suggested actions or products based on the analysis of performance metrics. That is, performance product recommendations can provide actionable insights for improving or optimizing performance. In some implementations, these recommendations can be automatically generated by AI models. For example, performance product recommendations can include suggestions for operational improvements (e.g., process optimization), new product development (e.g., introducing a new product line), strategic partnerships, or financial products like loan adjustments. In another example, recommendations can include adjustments to existing processes (e.g., streamlining workflows) or the use of new technologies.

Referring to performance indicator frameworks generally, performance indicator frameworks can be predefined templates or structures used to generate performance indicators. That is, performance indicator frameworks can provide a methodology for evaluating performance. In some implementations, the performance indicator frameworks can be industry-specific. For example, performance indicator frameworks can include templates for financial analysis (e.g., profitability assessments, issuing credit memos), operational assessments (e.g., efficiency evaluations), credit memoranda, and/or risk evaluations. In another example, the performance indicator frameworks can be customized to align with the goals and objectives of the entity.

In some implementations, the data interface 112 of the modeling system 110 can be configured to receive an input corresponding to an entity to model. That is, the input can be received periodically or in real-time according to a predefined schedule, on-demand via a user interface, and/or based on a detected event corresponding to the entity. For example, the predefined schedule can be daily, weekly, monthly, quarterly, or any periodic interval. In another example, on-demand can be triggered by a user request. In this example, the user interface (e.g., a web portal, mobile application, desktop software) can be used by the provider computing system 140 to initiate modeling. In yet another example, a detected event can be a significant financial transaction, a security breach, regulatory changes, a market shift, or any notable incident. In a detected event, the input can be received when the data interface 112 identifies such occurrences. In some implementations, the receipt of the input can be automated. For example, the data interface 112 can automatically queue the input to facilitate the data interface 112 accessing data sources.

In some implementations, the data interface 112 can be configured to access one or more data sources corresponding to the entity. For example, accessing can be responsive to the input. Generally, accessing data sources (e.g., entity computing system 150 and/or data sources 160) can include querying databases, retrieving files, and/or interfacing with external APIs. For example, the data interface 112 can send a request to a financial database to retrieve transaction history. That is, the data interface 112 can use network 130 (e.g., the Internet, intranet, VPN) to establish a connection. Furthermore, a communication session can be initiated between the data sources and the data interface 112. The communication session can establish a data channel such that the data interface 112 can securely transfer data. In some implementations, the data channel can be encrypted, authenticated, dedicated, or any secure communication link. For example, a communication session can be established between the data interface 112 and a data source 160. In this example, data source 160 can be a credit bureau, financial market database, regulatory body database, CRM system, ERP system, or any third-party data provider. In another example, a communication session can be established between the data interface 112 and an entity computing system 150. In this example, entity computing system 150 can be a financial system, operational database, transaction processing system, inventory management system, HR system, or any internal or external data source. In some implementations, the communication session can end when the data transfer is complete. That is, the data interface 112 can close the session to secure the data. For example, the data interface 112 can terminate the connection once the data is received and verified.

In some implementations, the modeling database 120 can be configured to store and organize data used in modeling by the modeling system 110. The data can include the performance data 122. The performance data 122 can contain financial reports, cybersecurity logs, historical transaction records, risk assessment results, or other metrics and data used in modeling and accessing performance. The data stored can be accessed and processed by the modeling system 110 to perform modeling and generate metrics and indicators. For example, the modeling system 110 can retrieve data from the performance data 122 to analyze trends in credit risk and detect potential cybersecurity threats. Additionally, the performance data 122 can be updated by the modeling system 110. In some implementations, the provider computing system 140, entity computing system 150, and/or data sources 160 can access and provide data to the modeling database 120. For example, data items regarding particular performance metrics or indicators can be provided by the provider computing system 140, entity computing system 150, and/or data sources 160 and stored in the performance data 122.

Referring still to FIG. 1, according to some implementations, the modeling system 110 can be configured to communicate with components of the computing system 100. For example, entity data, and/or modeling dataset associated with the provider computing system 140, the entity computing system 150, and/or data sources 160 can be communicated to the modeling system 110 (e.g., via the network 130). Information and/or data associated with the modeling database 120 can also be communicated to the modeling system 110. In some implementations, the modeling system 110 can be configured to communicate with the provider computing system 140. In some implementations, the provider computing system 140 can include one or more processing circuits, including processor(s) and memory. The memory can have instructions stored thereon that, when executed by processor(s), cause the one or more processing circuits to perform the various operations described herein. In some implementations, the provider computing system 140 can be used for submitting data inputs, communicating with the entity computing system 150 and/or data sources 160, and/or interacting with the GenAI outputs and providing feedback to the modeling system 110. For example, the provider computing system 140 can transmit data such as text, financial reports, and/or security logs related to the entity (e.g., in an unstructured or structured format).

The provider computing system 140 can also receive updates and feedback from the entity computing system 150 regarding the status of financial health or cybersecurity posture. The provider computing system 140 can perform preliminary validation of the data before transmission. In some implementations, the provider computing system 140 can execute algorithms to preprocess the data, such as normalization of financial figures or extraction of security events from logs. In some implementations, the input/output device of the provider computing system 140 can be configured to facilitate data entry and communication (e.g., entry of unstructured or structured data items, such as financial statements or security incident reports). For example, the input/output device can be used to input financial details, capture security logs or network activity, and/or display feedback from the modeling system 110. The input/output device can include various peripherals such as keyboards, touchscreens, virtual reality headsets, augmented reality headsets, sensors, scanners, displays, and/or cameras. These peripherals support precise and detailed data entry. The input/output device can also provide real-time prompts and guidance to the user (e.g., banker, analysts).

Additionally, the input/output device can support multiple modes of interaction, such as manual data entry and automated data capture. The input/output device can also display status updates and notifications, keeping the user (e.g., financial analyst, cybersecurity specialist, etc.) informed throughout the data analysis process or about trends from data items of the entity. Furthermore, the input/output device can be integrated with other systems of computing system 100 for data exchange. The input/output device can facilitate communication (e.g., over network 130) between various users or computing systems involved in the data analysis process and/or data items analysis, including financial departments, cybersecurity teams, third parties (e.g., external auditors, regulatory bodies) and the modeling system 110. Various interfaces and communication protocols can be used to achieve this integration. In some implementations, the provider computing system 140 can facilitate interactions with the modeling system 110 to generate performance indicators (e.g., compiled or populated credit memos, cybersecurity reports). The performance indicators can include annotations that allow the provider (e.g., banker) to interact with and modify the outputs. For example, the modeling system 110 can generate a credit memo with suggested loan terms based on the modeling data of the entity, which the banker can review and adjust through the provider computing system 140. The provider computing system 140 can also generate cybersecurity reports with recommended actions based on detected vulnerabilities, which cybersecurity teams can annotate and follow up on.

In some implementations, the modeling system 110 can be configured to communicate with the entity computing system 150. In some implementations, the entity computing system 150 can include one or more processing circuits, including processor(s) and memory. The memory can have instructions stored thereon that, when executed by processor(s), cause the one or more processing circuits to perform the various operations described herein. In some implementations, the entity computing system 150 can be used for submitting data inputs, communicating with the provider computing system 140 and/or data sources 160, and/or interacting with the GenAI outputs and providing feedback to the modeling system 110. For example, the entity computing system 150 can transmit data such as text, financial reports, invoices, financial statements, and/or security logs related to the entity (e.g., in an unstructured or structured format).

The entity computing system 150 can also receive updates and feedback from the provider computing system 140 regarding the status of financial health, performance metrics, performance indicators, or cybersecurity posture. The entity computing system 150 can perform preliminary validation of the data before transmission. In some implementations, the entity computing system 150 can execute algorithms to preprocess the data, such as normalization of financial figures or extraction of financial metrics or security events from logs. In some implementations, the input/output device of the entity computing system 150 can be configured to facilitate data entry and communication (e.g., entry of unstructured or structured data items, such as financial statements or security incident reports). For example, the input/output device can be used to input financial details, capture security logs or network activity, and/or display feedback from the modeling system 110. The input/output device can include various peripherals such as keyboards, touchscreens, virtual reality headsets, augmented reality headsets, sensors, scanners, displays, and/or cameras. These peripherals support precise and detailed data entry. The input/output device can also provide real-time prompts and guidance to the user (e.g., client, IT personnel).

Additionally, the input/output device can support multiple modes of interaction, such as manual data entry and automated data capture. The input/output device can also display status updates and notifications, keeping the user (e.g., client, IT personnel, etc.) informed throughout the data analysis process or about trends from data items of the entity. Furthermore, the input/output device can be integrated with other systems of computing system 100 for data exchange. The input/output device can facilitate communication (e.g., over network 130) between various users or computing systems involved in the data analysis process and/or data items analysis, including financial departments, cybersecurity teams, third parties (e.g., external auditors, regulatory bodies) and the modeling system 110. Various interfaces and communication protocols can be used to achieve this integration. In some implementations, the entity computing system 150 can facilitate interactions with the modeling system 110 to generate performance indicators (e.g., populated credit memos, cybersecurity reports). The performance indicators can include annotations that allow the entity (e.g., client) to interact with and modify the outputs. For example, the modeling system 110 can generate a credit memo with suggested loan terms based on the modeling dataset of the entity, which the client can review and adjust through the entity computing system 150. The modeling system 110 can also generate cybersecurity reports with recommended actions based on detected vulnerabilities, which cybersecurity teams can annotate and follow up on.

In some implementations, the data interface 112 can also be configured to identify a modeling dataset based on the accessing of the one or more data sources via one or more data channels. That is, the data sources can be various systems and devices described herein, such as provider computing system 140, entity computing system 150, and/or data sources 160. For example, the provider computing system 140 can be a system operated by a provider (e.g., financial institution, bank, credit union, investment firm, or any financial service provider). The provider computing system 140 can store or allow access to internal data (e.g., transaction records, customer profiles, loan details, risk assessments, credit scores, or any financial data) used by the modeling system 110 in prompt generation and modeling. In another example, the entity computing system 150 can be a system operated by an entity (e.g., customer, client, corporate entity, small business, government agency, or any organizational body). The entity computing system 150 can store or allow access to external data (e.g., operational metrics, inventory data, sales records, HR data, compliance records, or any business data) used by the modeling system 110 in prompt generation and modeling. In yet another example, the data sources 160 can be a system operated by a third-party (e.g., S&P, Moody's, government databases, industry benchmarks, or any external data provider). The data sources 160 can store or allow access to external data (e.g., market data, industry trends, regulatory updates, credit ratings, economic indicators, or any third-party data) used by the modeling system 110 in prompt generation and modeling.

In some implementations, identifying the modeling dataset can include populating the dataset by accessing external data from one or more external computing systems (e.g., entity computing system 150 and/or data sources 160). That is, the data interface 112 can send data requests to external systems to gather relevant information. For example, to access the entity computing system 150, the data interface 112 can perform one or more API calls and return one or more API responses. In this example, the entity computing system 150 can be a sales database, HR system, or inventory management system. In another example, to access the entity computing system 150, the data interface 112 can use secure file transfer protocols. In this example, data files can be transferred securely from the system of the entity to the modeling system 110. In another example, to access an enterprise resource planning (ERP) system (e.g., entity computing system 150), the data interface 112 can integrate with ERP data export functionalities. In this example, the ERP system can provide comprehensive business data for modeling. In yet another example, to access the data sources 160, the data interface 112 can use web scraping tools to gather data from publicly available sources. In this example, financial reports, market trends, and/or regulatory filings can be collected and included in the modeling dataset. That is, the data interface 112 can populate at least a portion of the modeling dataset by accessing external data and generating a data package and/or incorporating (or adding) the external data into the modeling dataset.

Generally referring to API interactions, the data interface 112 can authenticate API calls using tokens or keys to establish secure connections with external systems. In some implementations, the data interface 112 can handle rate limiting and retry mechanisms to manage API request quotas and ensure successful data retrieval. Additionally, the data interface 112 can parse the received API responses to extract relevant data fields and convert them into a format compatible with the modeling dataset. For example, JSON or XML data received from APIs can be parsed and transformed into structured tables. Error handling procedures can be implemented to manage and log any discrepancies or failures during the API interactions. The data interface 112 can also perform data validation checks to verify the accuracy and completeness of the retrieved data. In examples where data is incomplete or inconsistent, the data interface 112 can trigger additional requests or use fallback mechanisms to obtain the necessary information.

In some implementations, the data interface 112 can also be configured to use APIs to facilitate real-time data sets to be structured into larger data sets (e.g., modeling data) for the real-time creation of benchmarks, industry insights, and/or the structuring of performance indicators (e.g., credit memorandum) by the modeler 116 and/or performance system 118. That is, the data interface 112 can continuously pull data from various external and internal sources using API integrations. For example, real-time financial transactions, market data, and/or industry-specific metrics can be aggregated into the modeling data. The APIs can facilitate the retrieval of up-to-date information, allowing the modeling system 110 to maintain a current dataset. In another example, the data interface 112 can use APIs to retrieve real-time cybersecurity threat data, operational metrics, and/or compliance records, which can be incorporated into the modeling dataset to generate real-time security benchmarks and risk assessments. The modeler 116 can use enriched modeling dataset to generate dynamic benchmarks, providing industry insights that reflect the latest market conditions and operational performance. Furthermore, the performance system 118 can leverage this real-time data to structure performance indicators, such as credit memoranda, that can accurately reflect a current performance of the entity.

In some implementations, identifying the modeling dataset can also include populating the dataset by accessing internal data from one or more internal computing systems (e.g., provider computing system 140 and/or performance data 122 of modeling database 120). That is, the data interface 112 can access proprietary data systems within the network of the provider. For example, to access the provider computing system 140, the data interface 112 can perform secure database queries. In this example, the provider computing system 140 can be a financial transaction system. In another example, to access the provider computing system 140, the data interface 112 can interface with the internal APIs of the provider. In this example, the customer relationship management (CRM) data of the provider can be accessed. In another example, to access the performance data 122 of modeling database 120, the data interface 112 can execute SQL queries. In this example, historical performance metrics stored in the database can be retrieved. In yet another example, to access the provider computing system 140, the data interface 112 can use data integration middleware. In this example, the middleware can facilitate data exchange between different systems within the network of the provider. That is, the data interface 112 can populate at least a portion of the modeling dataset by accessing internal data and generating a data package and/or incorporating (or adding) the internal data into the modeling dataset.

In some implementations, internal data can include proprietary datasets. That is, the proprietary datasets can be exclusive to the provider. For example, the proprietary datasets can be customer financial histories. In another example, the proprietary datasets can be internal risk assessments. In yet another example, the proprietary datasets can be interest rates or interest rate computational functions. In some implementations, internal data can include exchange records. That is, the exchange records can be transaction logs. For example, the exchange records can be stock trade records. In another example, the exchange records can be foreign exchange transactions. In some implementations, internal data can include operational data. That is, the operational data can be business process information. For example, the operational data can be supply chain records. In another example, the operational data can be production schedules. In some implementations, internal data can include internal metrics (e.g., interest rates, benchmarks). That is, the internal metrics can be performance indicators. For example, the internal metrics can be key performance indicators (KPIs). In another example, the internal metrics can be financial ratios.

In some implementations, external data can include third-party datasets. That is, the third-party datasets can be provided by external entities. For example, the third-party datasets can be credit scores from credit bureaus. In another example, the third-party datasets can be industry benchmarks from market analysts. In yet another example, the third-party datasets can be invoices or financial statements of the entity. In some implementations, external data can include comparative performance metrics. That is, the comparative performance metrics can be benchmark data. For example, the comparative performance metrics can be industry averages. In another example, the comparative performance metrics can be competitor performance data. In some implementations, external data can include environmental factors. That is, the environmental factors can be external conditions affecting performance. For example, the environmental factors can be economic indicators. In another example, the environmental factors can be regulatory changes. In some implementations, external data can include demographic information. That is, the demographic information can be population statistics. For example, the demographic information can be age distribution. In another example, the demographic information can be income levels.

In some implementations, the prompt system 114 of the modeling system 110 can be configured to generate a prompt based on the modeling dataset, entity data of the entity, and/or one or more performance benchmarks for one or more AI models. For example, generating the prompt can include mapping one or more associations corresponding to the modeling dataset and one or more performance parameters of one or more performance indicators. In some implementations, the prompt system 114 can be configured to generate a prompt based on the structured and unstructured data within the modeling dataset, entity data, and/or performance benchmarks. That is, generating the prompt can include extracting one or more associations corresponding to the modeling dataset, entity data, and/or performance benchmarks. The associations can be categories or correlations between information of the modeling dataset. For example, the modeling dataset can include structured data, unstructured data, and/or historical data (e.g., past financial performance, previous security incidents). In another example, entity data can include specific details, characteristics, and/or properties of the entity (e.g., credit history, business size, industry sector, operational data, security posture).

As used herein, “unstructured data” can refer to both data not conforming to a predetermined form and/or substance, and/or data conforming to a plurality of different forms and/or substances. This includes data that cannot be converted or normalized into a specific form or substance for ingestion by the model. Unstructured data can include various formats such as text, images, videos, and/or sensor data. Unstructured data can also include any data that is inherently diverse in its formatting and content.

In some implementations, the associations extracted from the modeling dataset can include identifying correlations between the data points of the modeling dataset. For example, the prompt system 114 can determine patterns in financial transactions (e.g., payment histories), types of operational activities (e.g., transactions, network access), or recurring issues (e.g., late payments, security breaches). In another example, the prompt system 118 can determine correlations between external conditions (e.g., market trends, threat levels) and performance benchmarks (e.g., an industry-specific benchmark that provides performance metrics and benchmarks for various sectors, industry research and benchmarking that providers reports and comparative data on market performance, industry trends, and/or competitive analysis across numerous industries, industry standards, regulatory requirements, historical performance data). In some implementations, extracting the associations by the prompt system 114 can include analyzing data points for common themes and patterns. That is, extraction can include the prompt system 114 identifying relationships and trends within the data. For example, extraction can include parsing text for keywords and phrases indicative of certain activities (e.g., high-risk transactions, security alerts). In another example, extraction can include using natural language processing to interpret context and sentiment from operational notes (e.g., customer feedback, transaction logs, user activity reports, security incident reports). In some implementations, associations can be categories of activities (e.g., types of loans, security protocols), operational trends, risk factors, compliance statuses, or any identified pattern, types of issues (e.g., payment problems, cybersecurity vulnerabilities), or recurring patterns. That is, the prompt system 114 can link related data points to generate a prompt to facilitate modeling by modeler 116.

In some implementations, the prompt system 114 can generate or modify performance benchmarks. That is, the prompt system 114 can compile and analyze data to establish or refine standards for performance comparison. For example, the prompt system 114 can generate industry-specific financial performance benchmarks by aggregating financial data such as average revenue, profit margins, and/or return on investment from multiple companies within the industry, and then determining the standard benchmarks based on statistical analysis of this data. In another example, the prompt system 114 can generate operational efficiency benchmarks for manufacturing processes by collecting data on production cycle times, equipment efficiency, and/or defect rates from different facilities, and then using this data to establish standard performance benchmarks. In yet another example, the prompt system 114 can generate customer satisfaction benchmarks for service industries by analyzing customer feedback scores, service completion times, and/or retention rates from various service providers, and then defining standard satisfaction benchmarks. Additionally, the prompt can include a new or modified performance benchmark for modeling. That is, the modeler 116 can receive the prompt from the prompt system 114 that can include updated performance benchmarks derived from recent data analyses, ensuring the AI model incorporates the most current and accurate benchmarks for the entity.

Generally, standard performance benchmarks can be specific metrics used to evaluate and compare the performance of entities within an industry. These benchmarks can be established through data aggregation and statistical analysis of key performance indicators (KPIs). For example, financial performance benchmarks can include average revenue, profit margins, and/or return on investment, derived from multiple companies in the industry. In another example, operational efficiency benchmarks for manufacturing processes can include production cycle times, equipment utilization rates, and/or defect frequencies, collected from various facilities. In yet another example, customer satisfaction benchmarks for service industries can be based on customer feedback scores, service completion times, and/or retention rates. The prompt system 114 can generate or update these benchmarks and the modeler 116 can incorporate these updated benchmarks to improve the accuracy of performance models.

Additionally, categories can be financial activities (e.g., loan applications, credit card transactions), operational disruptions (e.g., service outages, cyberattacks), or compliance deviations (e.g., regulatory breaches). In this example, the associations of the data points can be used to understand the circumstances of activities. Additionally, the associations can be identified by the prompt system 114 between geographic locations (e.g., regional transaction trends, localized security threats) and activity frequencies. For example, the associations of the data points can be analyzed by the prompt system 114 for environmental factors (e.g., economic conditions, threat levels). Additionally, in this example, attribute information of the modeling dataset and entity data can be analyzed by the prompt system 114 for specific attributes like activity type (e.g., financial transaction type, security event type) and operational impact (e.g., credit risk, security breach severity). In some implementations, the extraction of the associations can be used to generate the prompts by the prompt system 114. The prompts can be structured to identify data points (e.g., of the modeling dataset) to facilitate AI model analysis.

In some implementations, generation of the prompt can include the prompt system 114 compiling the extracted associations into a query for the AI models. That is, the prompts can be used as input, with the data points, to one or more AI models of modeler 116. For example, the prompt system 114 can generate a prompt to ask the AI model to identify financial metrics specific to the operational context of the entity. In another example, the prompt system 114 can generate a prompt to analyze historical payment behaviors of the entity to assess future credit risk. In some implementations, prompts can be questions or commands. That is, the prompts can direct the AI models to focus and/or emphasize specific aspects of the data points in the modeling dataset. For example, a prompt can be “Determine the impact of seasonal revenue fluctuations on the creditworthiness of ABC Manufacturing Inc. ” In this example, the prompt can provide the one or more AI models with targeted data for analysis. In another example, a prompt can be “Analyze the payment history patterns for XYZ Retail Corp. in relation to economic downturns. ” In this example, the prompt can provide the one or more AI models with entity-specific parameters to generate the metrics for a lending credit memo. Additionally, while the prompt system 114 is disclosed for generating prompts based on the modeling dataset, entity data, and/or performance benchmarks (e.g., standard performance benchmarks), it should be understood that prompting can be bypassed or omitted. In such examples, the modeler 116 can perform modeling using the modeling dataset, entity data, and/or performance benchmarks without receiving a prompt as input.

In some implementations, the modeler 116 can be configured to apply the modeling dataset and the prompt as input to the one or more AI models to cause the one or more AI models to generate an output regarding one or more performance metrics of the entity to correspond to the one or more performance parameters. In some implementations, the output can include one or more performance product recommendations (e.g., alternative or combinational products, or a dynamic product) based on the one or more performance metrics. That is, the modeler 116 can apply the modeling dataset and the prompt as the input to the one or more AI models by transforming the plurality of modeling data into a plurality of feature vectors. For example, the feature vectors can be numerical representations of data attributes extracted from the data items of the modeling dataset. For instance, the text “consistent late payments” can be transformed into a feature vector [0.9, 0.3, 0.6] where each number represents a different attribute. In this example, 0.9 can correspond to the frequency of late payments, 0.3 can correspond to the impact on credit score, and 0.6 can correspond to the risk of future defaults. That is, transforming can include the modeler 116 converting textual and numerical data into structured numerical data. In another example, the feature vectors can be numerical representations of data attributes extracted from the data items of the modeling dataset. For instance, the text “unauthorized access attempt detected” can be transformed into a feature vector [0.7, 0.4, 0.8] where each number represents a different attribute. In this example, 0.7 can correspond to the severity of the threat, 0.4 can correspond to the likelihood of system compromise, and 0.8 can correspond to the potential impact on data integrity. That is, transforming can include the modeler 116 converting textual and security log data into structured numerical data to generate a cybersecurity risk assessment report.

In some implementations, the modeler 116 can apply the modeling dataset and the prompt as the input to the one or more AI models by normalizing the plurality of feature vectors to a scale. For example, the scale can be a range from 0 to 1 or standard deviation units. That is, normalizing can include the modeler 116 adjusting the data to a common scale to facilitate consistent input for the AI models. In some implementations, applying the plurality of modeling dataset and the prompt as the input to the one or more AI models can include the modeler 116 the normalized plurality of feature vectors into the one or more AI models to perform predictive and pattern recognition to cause the one or more AI models to generate the output.

That is, performing predictive and pattern recognition on the input (e.g., modeling dataset and the prompt) can include the modeler 116 analyzing the data to identify various factors, performance trends, and/or potential future credit issues or cybersecurity threats. That is, the identifications can then be quantified into performance metrics. The quantification can include using linear regression to calculate ratios, clustering algorithms to group similar data points, and/or normalization techniques to scale the data. For example, a factor can be the debt-to-income ratio of the entity. In this example, the debt-to-income ratio can be quantified into a performance metric by calculating the total debt divided by total income and normalizing this value between 0 and 1. That is, the performance metric can represent the leverage level of the entity. In another example, a performance trend can be the frequency of late payments. In this example, the frequency of late payments can be quantified into a performance metric by counting the occurrences within specified time intervals and applying exponential smoothing. That is, the performance metric can indicate the payment reliability of the entity. In yet another example, a potential future credit issue or cybersecurity threat can be an increase in unauthorized access attempts. In this example, the number of unauthorized access attempts can be quantified into a performance metric by aggregating log data and using anomaly detection algorithms such as Isolation Forest. That is, the performance metric can indicate security vulnerability or credit worthiness.

In some implementations, the AI model can be a neural network, decision tree, support vector machine, or any other analytical model. That is, the AI model of the modeler 116 can process the modeling dataset and the prompt to identify potential future credit risks, trends, or patterns in cybersecurity vulnerabilities. For example, the AI model can be a generative AI model. For example, processing the modeling dataset and the prompt can include the modeler 116 identifying recurring indicators and patterns that suggest a trend in creditworthiness or security posture, which are then quantified into performance metrics.

Applying the modeling dataset and the prompt as input can cause the one or more AI models of the modeler 116 to generate an output regarding one or more performance metrics of the entity to correspond to the one or more performance parameters. For example, the output regarding one or more performance metrics can be a credit risk score based on historical payment data. In another example, the output regarding one or more performance metrics can be a cybersecurity risk assessment based on detected vulnerabilities. That is, the performance metrics can correspond to the performance parameters in that they provide quantitative measures of the financial health or security posture of the entity. For example, a performance parameter can be the debt-to-income ratio. In this example, a performance metric can be the calculated debt-to-income ratio of the entity, which can correspond to the creditworthiness of the entity in that a higher ratio indicates higher financial risk. In another example, the performance parameters can be related to a financial overview, such as revenue (previous year), EBITDA (previous year), net income (previous year), total assets (current), total liabilities (current). In this example, a performance metric can be determined for the performance parameters. That is, the revenue (previous year) can be modeled by the AI model by ingesting historical financial data and applying time series analysis techniques to detect patterns and trends in monthly revenue figures (e.g., $1.2M in January, $1.5M in February). The EBITDA (previous year) can be modeled by the AI model by utilizing regression analysis to correlate operating expenses with profit margins, extracting meaningful relationships from the financial statements (e.g., $500K operating profit, $300K operating expenses). The total assets (current) can be modeled by the AI model by employing valuation models to process balance sheet data, enabling the tracking of asset acquisition, depreciation, and valuation changes over time (e.g., $5M in equipment, $3M in real estate).

In some implementations, the modeler 116 can use the prompt as a structured query for the AI model, specifying the relevant features and data within the modeling dataset. The modeler 116 processes this prompt by extracting the designated data points, transforming them into the feature vectors. The feature vectors can be normalized to ensure consistent scaling across the dataset. The modeler 116 can apply machine learning models or algorithms, such as neural networks or support vector machines, to analyze the relationships and patterns among the features. Thus, the modeler 116 can generate performance metrics that quantify the financial, operational efficiency, cybersecurity resilience, risk management, compliance, creditworthiness, market position, customer satisfaction, loan repayment ability, system reliability, data integrity, threat detection, liquidity, and/or leverage posture of the entity based on the specified performance parameters.

Generally, performance parameters can be financial health indicators, efficiency metrics, and/or other relevant criteria that determine the creditworthiness or overall performance of an entity. These parameters can include risk assessment metrics, approval guidelines, rate settings, repayment terms, limit policies, fraud detection mechanisms, data privacy standards, security protocols, compliance requirements, operational workflows, and/or any other relevant parameter that influences the configuration and management of performance products (e.g., corresponding to the performance indicators generated for the one or more performance products). In some implementations, the output by the modeler 116 can include a recommendation to update a limit parameter for a product. That is, the modeler 116 can include a decision engine or model that outputs one or more recommendations based on the performance metrics. For example, the recommendations from the decision engine can include adjustments to operational procedures, security measures, or other relevant parameters. In another, the decision engine can suggest adjusting the limit for high-risk entities based upon modeling. In another example, the decision engine can recommend an update to a security protocol. In this example, the decision engine can recommend enhancing security measures for systems frequently targeted by threats.

In some implementations, the modeler 116 can be configured to apply (i) the modeling dataset, (ii) entity data of the entity, and/or (iii) one or more performance benchmarks as input to the one or more AI models to cause the one or more AI models to generate an output regarding one or more performance metrics of the entity to correspond to one or more performance parameters. Instead of using prompts the modeler 116 can directly process the input data by leveraging predefined rules and algorithms. That is, the modeler 116 can function and operate similarly as described above but without prompts the modeler 116 can utilize built-in heuristics and models to interpret the data. For example, the modeler 116 can detect relevant features and patterns within the dataset using unsupervised learning techniques. In some implementations, training the AI model without prompts can include feeding raw data into the AI models, which learn to identify significant correlations and trends autonomously. That is, the modeler 116 can dynamically adjust to new data inputs and refine its analysis. For example, the modeler 116 can update its parameters based on real-time data, updating the accuracy of the generated performance metrics and recommendations.

As discussed herein, the modeler 116 can utilize machine learning, generative artificial intelligence, or other advanced computing techniques. That is, the one or more AI models can include a generative AI model. The generative AI model can include at least one of (i) a supervised learning model trained on labeled performance indicators of a plurality of historical performance indicators or (ii) an unsupervised learning model trained on unlabeled performance indicators of the plurality of historical performance indicators. In some implementations, generative artificial intelligence (GenAI or GAI) models (also referred to as generative machine learning (ML) models) and/or other AI/ML models discussed herein can be implemented via and/or coupled to the modeler 116. That is, the modeler 116 can be configured to implement machine learning, facilitating the learning and adapting of the modeling system 110 operations without being explicitly programmed. Machine learning and artificial intelligence can be implemented using a variety of methods and algorithms. In some implementations, a machine learning module or circuit within modeler 116 can be configured to implement these ML methods and algorithms to continuously improve prediction accuracy and pattern recognition capabilities (e.g., related to the performance metrics).

In some implementations, the GenAI or GAI models can be transformer-based models, LLM-based models, recurrent neural networks (RNNs), or any suitable AI/ML models. For example, the GenAI model can be a transformer-based model that uses self-attention mechanisms to analyze sequential data. The transformer-based model can include multiple layers of attention heads and feed-forward networks. In another example, the GenAI model can be an LLM-based model that uses large-scale datasets to extract patterns and generate predictions (e.g., performance metrics such as credit worthiness, security threat levels, loan repayment probabilities, other performance related actions). Generally, the GenAI models can process the modeling dataset by identifying contextual relationships, extracting relevant features, and generating outputs based upon learned patterns.

In some implementations, the GenAI model can be an LLM-based model that can be implemented by processing a large-scale dataset to extract patterns and generate predictions. For instance, the LLM model architecture can include layers designed to handle large amounts of data for language modeling tasks. The architecture can use recurrent neural networks (RNNs), long short-term memory (LSTM) networks, or gated recurrent units (GRUs) to manage sequential dependencies. Embeddings can be used to convert words and sub words into numerical representations, retaining information about the semantic relationships between tokens. The GAI model can be trained using this data, performing forward and backward propagation to update model weights using optimization algorithms with a scheduled learning rate, and/or measuring performance with loss functions such as cross-entropy loss. Techniques like gradient clipping can mitigate exploding gradients, and/or dropout can prevent overfitting. Post-training, the model can generate text by predicting the next token in a sequence based upon learned patterns, potentially implementing decoding techniques to enhance the relevance of the generated content.

In some implementations, an AI model can be trained by the modeler 116 by using historical performance data (e.g., stored in performance data 122) to learn patterns and make predictions. That is, training can include feeding the modelling datasets of past financial transactions, loan repayments, and/or security incidents. For example, a GenAI model can be trained by using labeled data of past loan defaults and successful repayments. In this example, after training, the GenAI model can be implemented by the modeler 116 to generate outputs one or more performance metrics of the entity to correspond to the one or more performance parameters. The GenAI model can be used by the modeler 116 to identify performance product recommendations based on the one or more performance metrics.

In some implementations, GenAI model can be a supervised learning model trained on labeled performance indicators of a plurality of historical performance indicators. That is, the supervised learning model can be trained by the modeler 116 using datasets where outcomes are known and used to guide learning. For example, historical performance indicators labeled as high-risk or low-risk can be used to train the model to predict creditworthiness. In some implementations, GenAI model can be an unsupervised learning model trained on unlabeled performance indicators of the plurality of historical performance indicators. That is, the unsupervised learning model can be trained by the modeler 116 using data without predefined categories to identify hidden patterns. For example, analyzing historical performance indicators without labels to generate performance metrics used to generate a new performance indicator. Once trained, the GenAI can be implemented by the modeler 116 to monitor and analyze new modeling datasets to provide outputs.

In some implementations, the supervised learning model and/or the unsupervised learning model can include an association detector to generate the performance metrics. The association detector can be executable code or a data package that the modeler 116 uses to analyze patterns in the modeling dataset. The association detector can be used by the learning model during training by the modeler 116 or during implementation to identify relationships between various data points. That is, the association detector can be used by the modeler 116 in predicting a profitability trend or a cash flow based upon the modeling dataset and used in generating the performance indicator. For example, generating the performance metrics can include the modeler 116 tracking seasonal variations.

In some implementations, the supervised learning model and/or the unsupervised learning model can include a pattern tracker used by the modeler 116 to generate the performance metrics. The pattern tracker can be executable code or a data package that the modeler 116 uses to identify recurring patterns within the modeling dataset. The pattern tracker can be used by the learning model during training by the modeler 116 or during implementation to track the occurrence of patterns over time. That is, the pattern tracker can be used by the modeler 116 in identifying recurring patterns or trends in the data. For example, generating the performance metrics can include the modeler 116 tracking variations in KPIs over different time periods.

In some implementations, the modeler 116 can facilitate reinforcement learning of the one or more models (e.g., AI model, GenAI model, etc.). Reinforcement learning can include updating the GenAI model based upon receiving feedback on the output and the at least one action from a reward signal generated from performance metrics or performance indicators. In some implementations, the feedback can correspond to at least one user interaction with a user interface. The reward signal can be a quantitative measure of the performance of the model. For example, a data security analysis can provide a user interaction that validates the detected vulnerabilities and suggests improvements. In another example, a user can provide a user interaction that approves or adjusts the recommended actions based on the performance metrics.

Generating the reward signal from the performance metrics can include the modeler determining the accuracy and effectiveness of the predictions of the model. That is, the modeler 116 can improve the AI models by incorporating real-time feedback. For example, a performance metric can be the accuracy of performance metric predictions, and the reward signal can be generated by the modeler 116 to compare predicted outcomes to actual performance metrics. As shown, the feedback on the output can be used to refine the AI model. The modeler 116 can use the feedback to perform reinforcement learning on a model by adjusting its parameters based upon the reward signal. For example, the modeler 116 can increase the weight of certain variables of models that lead to more accurate predictions.

In some implementations, feedback on the output can be received from a provider computing system 140. For example, a banker or another individual operating the provider computing system 140 can interact with the modeler 116 implementing a GenAI model (e.g., a prompt element on a display) by providing feedback on the generation of a performance indicator (using the performance metrics) and/or performance metric outputs. The interaction with a prompt element can be received by the modeler 116 to update the model based upon insights. The modeler 116 can use the feedback (e.g., the interaction, such as accepting or rejecting a performance metric) to perform reinforcement learning on a model by refining its decision-making process. For instance, if a banker consistently overrides a specific performance metric output, the modeler 116 can train the model to adjust outputs to align better with human judgment.

In some implementations, the performance system 118 can be configured to generate one or more performance indicators of the entity based on the one or more performance metrics. That is, the performance system 118 can use a performance indicator framework to generate the one or more performance indicators. For example, the performance indicator framework can be a template document, algorithmic model, set of rules, predefined structure, or any customizable framework used in generating the performance indicators (e.g., cybersecurity memorandum, credit memorandum, risk assessment report, compliance audit, performance review, or any other analytical document). In some implementations, the generation of one or more performance indicators can include data integration and analysis. That is, the performance system 118 can aggregate and process relevant data to generate comprehensive reports. For example, to generate a memorandum for a credit approval request, the performance system 118 can use the performance metrics (e.g., financial metrics, credit facility metrics, client metrics, etc.) and/or other data to assess creditworthiness and financial stability. In this example, the performance system 118 can compile and present the analysis in a structured credit memorandum. In another example, to generate a memorandum for a cybersecurity validation request, the performance system 118 can use the performance metrics (e.g., threat detection metrics, vulnerability assessment results, incident response times) and/or other data to evaluate the cybersecurity posture of the entity. In this example, the performance system 118 can compile and present the analysis in a structured cybersecurity memorandum. In yet another example, to generate a memorandum for a compliance audit request, the performance system 118 can use the performance metrics (e.g., regulatory adherence scores, internal policy compliance rates, audit findings) and/or other data to assess the compliance status of the entity. In this example, the performance system 118 can compile and present the analysis in a structured compliance audit memorandum.

In some implementations, the modeling to generate performance metrics and the generation of performance indicators can be representative of an underwriting process. The underwriting process can be based on the analysis of performance metrics and parameters relevant to the entity. That is, the performance system 118 can utilize the performance indicator framework to structure the underwriting documentation. For example, the performance metrics can include financial ratios, liquidity measures, and/or historical payment records. In this example, the performance system 118 can generate an underwriting report detailing the financial health and creditworthiness of the entity. In another example, the performance metrics can include cybersecurity incident frequencies, response times, and/or vulnerability assessments. In this example, the performance system 118 can generate a cybersecurity risk report summarizing the security posture of the entity. The performance system 118 can integrate these metrics into standardized templates, ensuring consistency and accuracy in the generated reports. The structured reports can then be used by the provider (e.g., banker) to make informed decisions regarding credit approvals or cybersecurity measures. Additionally, the performance system 118 can facilitate the continuous update of these reports as new data becomes available.

In some implementations, the performance product recommendations can include a performance update, including an update to a term or condition of the one or more performance indicators based on the one or more performance metrics. For example, the modeler 116 can recommend adjusting the loan term from two years to three years based on the performance metric indicating a strong debt-to-income ratio improvement. In this example, the extended loan term can provide better alignment with the repayment capability of the entity as quantified by the debt-to-income ratio metric. In another example, the modeler 116 can recommend a lower interest rate based on a high credit score derived from the performance metrics. In this example, the reduced interest rate can be justified by the high credit score metric.

In some implementations, the performance update can facilitate dynamic cybersecurity management such that an entity can optimize its security posture and incident response strategies. For example, the modeler 116 can suggest reallocating security resources based on the performance metrics indicating shifts in threat levels. The AI model can analyze the security data and projected threat vectors of the entity using machine learning algorithms to identify patterns and trends. The performance metrics can highlight areas where additional security measures can be implemented without significantly increasing operational costs. Furthermore, the modeler 116 can provide insights into the impact of different security protocols by simulating various attack scenarios, such as the effect of implementing multi-factor authentication versus single-factor authentication. By evaluating these scenarios, the AI model can recommend security structures that enhance protection and response efficiency. In another example, the modeler 116 can identify opportunities for threat intelligence sharing by analyzing security incident data and industry trends. The AI model can also use clustering algorithms to segment the security incidents based on risk profiles and performance metrics.

Additionally, the performance update can facilitate dynamic portfolio management such that an entity can optimize its credit exposure and balance sheet implications. For example, the modeler 116 can suggest reallocating credit lines based on the performance metrics indicating sectoral shifts in creditworthiness. The AI model can analyze the financial health and projected cash flows of the entity using machine learning algorithms to identify patterns and trends. The performance metrics can highlight areas where additional credit can be extended without significantly increasing risk. Furthermore, the modeler 116 can provide insights into the balance sheet impact of different credit products by simulating various credit scenarios, such as the effect of extending long-term loans versus short-term credit facilities. By modeling these scenarios, the AI model implemented by the modeler 116 can recommend credit structures that enhance liquidity and capital efficiency. In another example, the modeler 116 can identify opportunities for securitization of loans by analyzing loan performance data and market conditions. The AI model can also use clustering algorithms to segment the loan portfolio based on risk profiles and performance metrics.

In some implementations, the performance product recommendations can include a performance update including a product update including a new performance indicator based on the one or more performance metrics. For example, the modeler 116 can identify high inventory levels and recommend financing equipment purchases through inventory-backed loans based on performance metrics showing high inventory turnover. In this example, the inventory-backed loan can leverage the inventory turnover metric to provide liquidity (e.g., the high turnover rate quantitatively indicating strong asset liquidity). In another example, the modeler 116 can detect a pattern of delayed payments and recommend restructuring receivables to improve cash flow management based on performance metrics indicating frequent payment delays. In this example, the restructuring of receivables can address the delays quantified by the payment delay metrics.

Additionally, the product update can facilitate dynamic product offerings such that an entity can continuously update to changing conditions and operational performance. For example, the AI model integrated within the modeler 116 can be used to analyze cash flow patterns of an entity and recommend dynamic credit lines that adjust limits based on real-time financial health indicators. In another example, the AI model can monitor sales of an entity and inventory data to offer dynamically adjusting loan terms that align with the current sales performance and inventory levels of the entity. In yet another example, the AI model can evaluate customer transaction histories and suggest personalized loan products or credit enhancements that are customized to individual customer financial behaviors. Furthermore, the AI model can integrate entity invoices, financial statements, and/or external economic data, such as interest rate changes and market trends, to adjust loan terms and credit offerings in real-time. That is, the dynamic capability improves the modeling system 110 by offering more responsive and tailored products. The AI model within the modeler 116 can also generate predictive analytics to forecast future financial needs of an entity and recommend proactive credit or loan adjustments.

Additionally, the product update can facilitate the structuring and syndication of credit products. For example, the AI model within the modeler 116 can analyze the financial health and risk profiles of entities to recommend an improved structure for loan syndication. For example, the modeler 116 can determine optimal loan sizes, interest rates, and/or maturity periods that align with market demand and risk tolerance. The AI model can also assess market conditions and investor preferences to structure credit products that are attractive for syndication. By evaluating historical loan performance and current market trends, the modeler 116 can identify opportunities for issuing new credit products that meet the strategic objectives of both the entity and potential investors. In another example, the AI model can suggest structuring bonds with features that align with the risk and return profiles desired by investors.

Additionally, the product update can facilitate the structuring and syndication of cybersecurity products. For example, the AI model within the modeler 116 can analyze the security posture and threat profiles of entities to recommend an improved structures for cybersecurity measures. This can include determining optimal security layers, response protocols, and/or monitoring systems that align with the risk tolerance and compliance requirements of the entity. The AI model can also assess emerging threat landscapes and regulatory changes to structure cybersecurity products that are robust and compliant. By evaluating historical security incidents and current threat trends, the modeler 116 can identify opportunities for implementing new security protocols that enhance the defense mechanisms of the entity. In another example, the AI model can suggest structuring incident response plans with features that align with the risk profiles and compliance needs of the entity.

In some implementations, the modeler 116 can receive a request from a third-party (e.g., financial institutions, cybersecurity firms, regulatory agencies, insurance companies, or any other relevant) computing system to re-model the entity. That is, the operator of the provider computing system 140 can submit a request to re-model the entity to obtain new performance metrics. For example, a provider computing system 140 can request a re-model when there is a significant change in the financial status of the entity, such as a new funding round or an asset acquisition. In another example, a provider computing system 140 can request a re-model when there is a detected increase in cybersecurity threats or incidents requiring a reassessment of the risk profile of the entity.

In some implementations, the data interface 112 can detect an update of an entry in the one or more data sources to re-model the entity. That is, the data interface 112 can detect updates by monitoring changes in connected databases and real-time data feeds (or channels). For example, a data source 160 can update financial records with new quarterly results. In another example, an entity computing system 150 can log changes in cybersecurity policies following a security audit. In another example, a data source 160 can report adjustments in market conditions affecting the operations of the entity. In some implementations, detecting can include the data interface 112 implementing access and query protocols to identify updates and request a re-model by the modeler 116.

In some implementations, the performance system 118 can be configured to transmit the one or more performance indicators and the one or more performance product recommendations to the provider computing system 140. That is, the performance system 118 can use network 130 to facilitate a communication session with the provider computing system 140. For example, the performance system 118 can establish a secure data transfer using encryption protocols. Additionally, transmitting can include formatting the performance indicators and recommendations into a standardized report format compatible with the provider computing system 140. For example, the performance system 118 can package the data into XML or JSON formats for integration. In some implementations, the performance system 118 can include real-time push notifications to alert the provider of newly available performance indicators and recommendations.

In some implementations, the one or more performance indicators can include one or more AI responses annotating the one or more performance indicators for review. In some implementations, the modeler 116 can generate one or more AI responses annotating the one or more performance indicators, which can include metadata annotations corresponding to data provenance, model confidence levels, and/or feature importance scores. That is, the annotations can be provided to the provider computing system 140 to use in reviewing the generated performance indicators. For example, a metadata annotation corresponding to data provenance can be a timestamp indicating when and where the data was sourced. In another example, a metadata annotation corresponding to a model confidence level can be a percentage score reflecting the certainty of the performance metrics outputted by the AI model. In yet another example, a metadata annotation corresponding to a feature importance score can be a ranked list showing the impact of different variables on the performance metric. That is, the modeler 116 can perform as a co-pilot with the provider, providing insights and explanations to support the review by the provider and decision-making processes.

In some implementations, the performance system 118 can be configured to cause a user interface of the provider computing system 140 to display the output, including a prompt element for receiving user input (e.g., facilitated via the modeler 116). That is, the prompt element can be an interactive field or button that allows users to provide additional information or feedback. For example, the prompt element can be a text box where users can enter specific details about a claim. In some implementations, the user interface can be a web-based application or a mobile app interface. For example, a user interface displayed on the provider computing system 140 can be a dashboard depicting the populated performance indicators and prompts for additional information. In this example, a security analyst can interact with the prompt element of the modeler 116 by entering details about recent security incidents to refine the output. In another example, a user interface displayed on the provider computing system 140 can be a cybersecurity assessment report with interactive elements. In this example, a security analyst can interact with the prompt element of the modeler 116 by providing updated threat intelligence data to adjust the performance metrics and/or performance indicator. In yet another example, a user interface displayed on the provider computing system 140 can be a credit memorandum with interactive elements. In this example, a loan officer can interact with the prompt element of the modeler 116 by providing updated financial information or client feedback to adjust the performance metrics and/or performance indicator.

In some implementations, the modeler 116 can be configured to generate a query according to the at least one performance metric or the generated performance indicator. The query can be generated during an active session between a plurality of users. For example, the active session can be an active session with a GenAI application or a collaborative workspace. That is, during an active session between a plurality of users, the active session can include an active connection between a first computing system of a first user and a second computing system of a second user. In some implementations, the first user and/or the second user can be digital users, chatbots, or GenAI interfaces that can facilitate interaction and data exchange. For example, the active connection can be between a provider operating the provider computing system 140 and the modeling system 110 such that the modeler 116 of the modeling system 110 can provide real-time performance metrics and indicators.

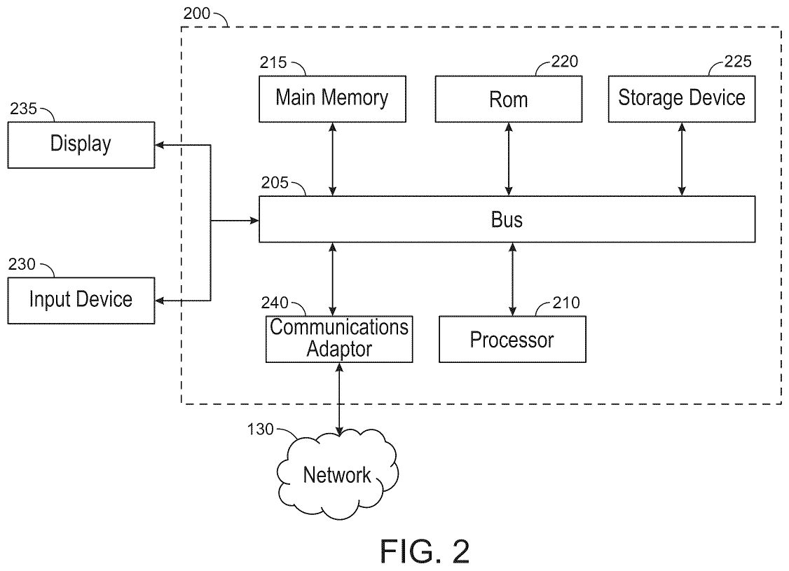

Referring now to FIG. 2, a depiction of a computing system 200 is shown. The computing system 200 that can be used, for example, to implement a computing system 100 of FIG. 1, the modeling system 110, modeling database 120, provider computing system(s) 140, entity computing system(s) 150, data sources 160, and/or various other example systems described in the present disclosure. The computing system 200 includes a bus 205 or other communication component for communicating information and a processor 210 coupled to the bus 205 for processing information. The computing system 200 also includes main memory 215, such as a random-access memory (RAM) or other dynamic storage device, coupled to the bus 205 for storing information, and instructions to be executed by the processor 210. Main memory 215 can also be used for storing position information, temporary variables, or other intermediate information during execution of instructions by the processor 210. The computing system 200 can further include a read only memory (ROM) 220 or other static storage device coupled to the bus 205 for storing static information and instructions for the processor 210. A storage device 225, such as a solid-state device, magnetic disk or optical disk, is coupled to the bus 205 for persistently storing information and instructions.

The computing system 200 can be coupled via the bus 205 to a display 235, such as a liquid crystal display, or active matrix display, for displaying information to a user. An input device 230, such as a keyboard including alphanumeric and other keys, can be coupled to the bus 205 for communicating information, and command selections to the processor 210. In another arrangement, the input device 230 has a touch screen display 235. The input device 230 can include any type of biometric sensor, a cursor control, such as a mouse, a trackball, or cursor direction keys, for communicating direction information and command selections to the processor 210 and for controlling cursor movement on the display 235.

In some implementations, the computing system 200 can include a communications adapter 240, such as a networking adapter. Communications adapter 240 can be coupled to bus 205 and can be configured to provide communications with a computing or communications network 130 and/or other computing systems. In some illustrative implementations, any type of networking configuration can be achieved using communications adapter 240, such as wired (e.g., via Ethernet), wireless (e.g., via Wi-Fi, Bluetooth), satellite (e.g., via GPS) pre-configured, ad-hoc, LAN, WAN.

According to various implementations, the processes that effectuate illustrative implementations that are described herein can be achieved by the computing system 200 in response to the processor 210 executing an arrangement of instructions contained in main memory 215. Such instructions can be read into main memory 215 from another computer-readable medium (CRM), such as the storage device 225. Execution of the arrangement of instructions contained in main memory 215 causes the computing system 200 to perform the illustrative processes described herein. One or more processors in a multi-processing arrangement can also be employed to execute the instructions contained in main memory 215. In alternative implementations, hard-wired circuitry can be used in place of or in combination with software instructions to implement illustrative implementations. Thus, implementations are not limited to any specific combination of hardware circuitry and software.

That is, although an example processing system has been described in FIG. 2, implementations of the subject matter and the functional operations described in this specification can be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. implementations of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the implementations of FIG. 2 as singular, stand-alone devices, one of ordinary skill in the art will appreciate that, in some implementations, the computing system 200 can include virtualized systems and/or system resources. For example, in some implementations, the computing system 200 can be a virtual switch, virtual router, virtual host, virtual server. In some implementations, computing system 200 can share physical storage, hardware, and other resources with other virtual machines. In some implementations, virtual resources of the network can include cloud computing resources such that a virtual resource can rely on distributed processing across more than one physical processor, distributed memory, etc.

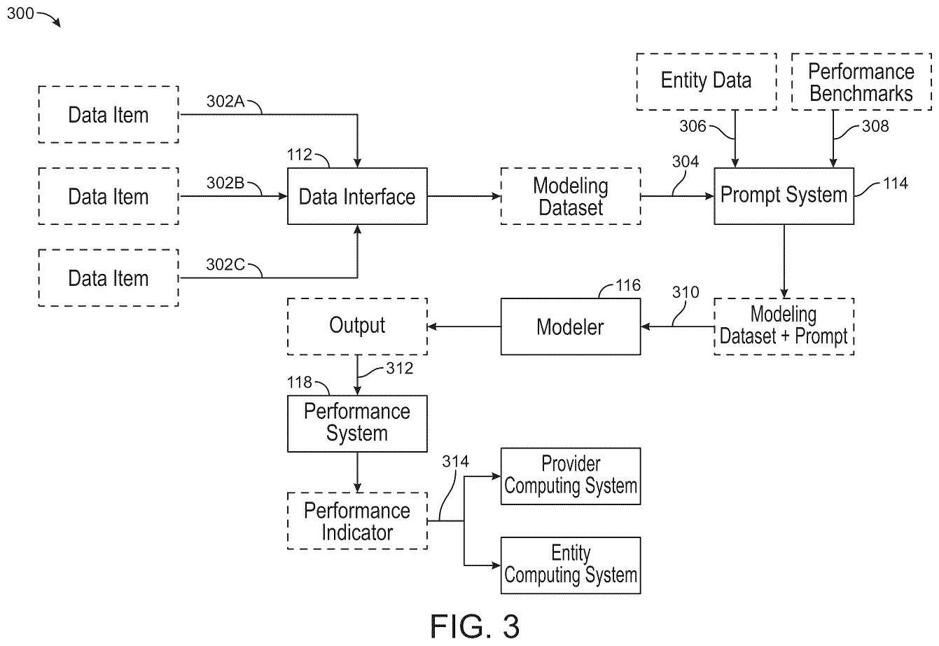

Referring now to FIG. 3, a flow diagram of an exemplary computer-implemented or computer-based process of modeling data items is shown, according to some implementations. It should be understood that the solid-lined boxes or blocks represent components or systems within the modeling system 300, while the dotted-lined boxes or blocks indicate data flow or intermediate data states processed by these components or systems.

At blocks 302A, 302B, and 302C, the data interface 112 can receive data items from various sources (e.g., financial statements, invoices, security logs). For example, data items can include details associated with a plurality of financial transactions and security events corresponding to at least one entity. In some implementations, the data interface 112 can collect and prepare the data items for further processing. That is, the data interface 112 can convert the various formats into a standardized modeling dataset (e.g., text conversion, metadata extraction, structured formatting). The data interface 112 can process a variety of data formats and structures.

At block 304, once the data items are received and the modeling dataset is populated (or identified) by the data interface 112, the modeling dataset can be forwarded to the prompt system 114. For example, the data items can now be in a form suitable for generating prompts (e.g., pre-processed text, formatted financial statements, structured logs). In some implementations, the prompt system 114 can analyze this data to extract relevant information and create prompts that can guide the modeler 116. That is, generating the prompt can include mapping one or more associations corresponding to the modeling dataset and one or more performance parameters of one or more performance indicators. The prompt system 114 can generate a prompt for effective modeling and analysis.

At blocks 306 and 308, the prompt system 114 can receive additional inputs such as entity data and performance benchmarks. The entity data can include specific details about the entity (e.g., business type, size, financial health) and the performance benchmarks can include industry standards and historical performance metrics. In some implementations, the prompt system 114 combines the modeling dataset with these additional inputs to generate a prompt (e.g., shown as modeling dataset+prompt).

At block 310, the prompt system 114 can combine the modeling dataset with the generated prompts and send this combined data to the modeler 116. For example, the modeler 116 can model this combined data to generate outputs regarding performance metrics (e.g., risk assessments, trend analyses, predictive modeling). In some implementations, applying the modeling dataset and the prompt as the input to the one or more AI models can include transforming the modeling dataset into a plurality of feature vectors and normalizing the feature vectors to a scale. That is, the combined data can allow the modeler 116 to output accurate and informed predictions and/or metrics (e.g., probability scores, anomaly detection, future trend forecasts). The output from the modeler 116 can be used for further processing by the performance system 118.

At block 312, the output generated by the modeler 116 can be sent or otherwise made available to the performance system 118 for analysis and action. For example, the output can include insights and predictions based upon the modeling dataset and prompts (e.g., updated risk profiles, recommended actions, flagged issues). In some implementations, the performance system 118 can use this output to generate performance indicators.

At block 314, the performance system 118 can transmit the performance indicators and/or product recommendations to the provider computing system 140 and the entity computing system 150. For example, the provider computing system 140 can receive a credit memorandum with updated terms based on the performance metrics. The entity computing system 150 can receive a cybersecurity assessment with recommended actions to enhance security posture. The performance indicators and recommendations can be displayed through a user interface, facilitating real-time feedback and interaction with the generated insights.

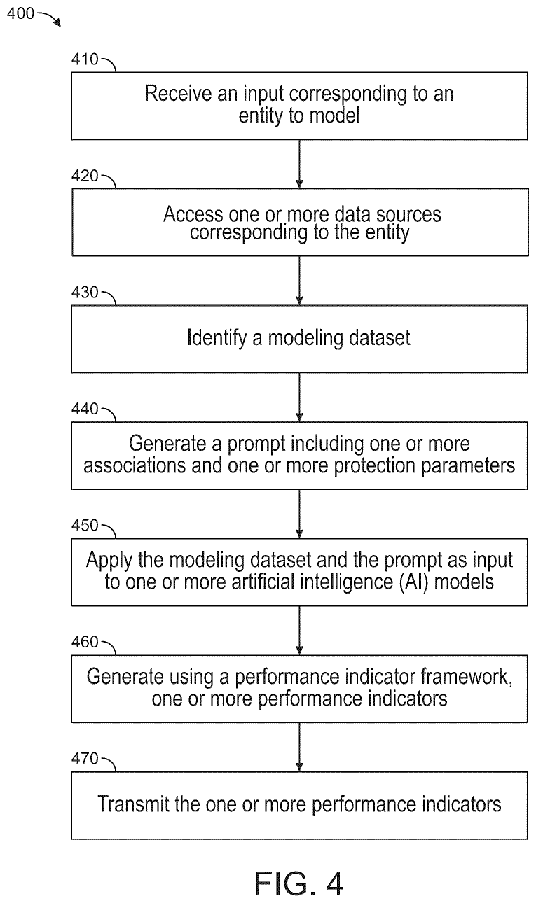

Referring now to FIG. 4, depicting a method to protect cross-system exchanges, according to some implementations. At least one of the example system of FIG. 1, or the example modeling system 300 of FIG. 3, can perform method 400 according to present implementations.

In broad overview of method 400, at block 410, the one or more processors (e.g., modeling system 110) can receive an input corresponding to an entity to model. At block 420, the one or more processors can access one or more data sources corresponding to the entity. At block 430, the one or more processors can identify a modeling dataset. At block 440, the one or more processors can generate a prompt including one or more associations and one or more protection parameters. At block 450, the one or more processors can apply the modeling dataset and the prompt as input to one or more artificial intelligence (AI) models. At block 460, the one or more processors can generate using a performance indicator framework, one or more performance indicators. At block 470, the one or more processors can transmit the one or more performance indicators. In some implementations, additional, fewer, or different operations can be performed in method 400 depending on the particular implementation. In some implementations, some, or all operations of method 400 can be performed by one or more processors executing on one or more computing devices, systems, or servers. In some implementations, at least one operation can be re-ordered, added, removed, or repeated. Additionally, some or all of the operations performed by the blocks can be removed or added.

In broad overview, method 400 relates to the generation of dynamic memorandums and cybersecurity assessments by integrating data elements from various data sources. By synchronizing statements, operational data, and/or security logs, method 400 improves the accuracy and reliability of performance metrics used in generating performance indicators. Method 400 relates to a platform for data intake, integrating multiple data sources to generate dynamic memorandums and cybersecurity. The platform can collect data, extracts data from third-party APIs, and/or connects to client ERP and finance systems. Additionally, method 400 can incorporate broader industry benchmarks to create ratios and aggregate exposures by industry, company size, and/or geography. Method 400 can be used to facilitate real-time creation of benchmarks and industry insights. Method 400 can also use the integrated data to improve credit decisioning, risk assessment, and/or portfolio management, including dynamic product structuring and syndication based on performance metrics and benchmarks.

At block 410, the processors (e.g., data interface 112) can receive an input corresponding to an entity to model. The input can indicate the entity or group of entities to model (e.g., generate metrics and indicators). In some implementations, input is received (i) periodically according to a predefined schedule, (ii) on-demand via a user interface, or (iii) based on a detected event corresponding to the entity (or group of entities).

At block 420, the processors (e.g., data interface 112) can access one or more data sources corresponding to the entity. In some implementations, accessing can be responsive to the input and the accessing can be facilitated using one or more data channels. That is, the data sources can be external or internal to a provider. In some implementations, the processors can populate the modeling dataset (in block 430) based on the processors accessing external data from one or more external computing systems and/or accessing internal data from one or more internal computing systems. For example, the external data can include at least one of third-party datasets, comparative performance metrics, environmental factors, or demographic information. In another example, the internal data can include at least one of proprietary datasets, exchange records, operational data, or internal metrics.

At block 430, the processors (e.g., data interface 112) can identify a modeling dataset. In some implementations, identifying can be based on the accessing of the one or more data sources via the one or more data channels. The modeling dataset can be an aggregation or grouping of data collected from the various internal and external sources. In some implementations, the modeling dataset can include a plurality of unstructured data items corresponding to non-relational data generated by the one or more data sources.

At block 440, the processors (e.g., prompt system 114) can generate a prompt based on (i) the modeling dataset, (ii) entity data of the entity (or group of entities), and/or (iii) one or more performance benchmarks. The prompt can be generated for the one or more AI models. In some implementations, generating the prompt can include mapping one or more associations corresponding to the modeling dataset and one or more performance parameters of one or more performance indicators. In some implementations, the processors can generate or identify the performance benchmarks. The benchmarks can be templates or standardized points of reference used to generate a prompt that guides the AI model in evaluating the modeling dataset and entity data. In some implementations, mapping can include linking specific data points from the modeling dataset to the criteria used for evaluation to issue the performance indicator. In some implementations, the performance parameters can be health indicators, efficiency metrics, and/or other relevant criteria that determine the overall performance of a company or entity. Additionally, the performance indicator can be a memorandum or proof that is desired to be generated by a provider. In some implementations, the AI models can include a generative AI model. For example, the generative AI model can include a supervised learning model trained on labeled performance indicators of a plurality of historical performance indicators. In another example, the generative AI model can an unsupervised learning model trained on unlabeled performance indicators of the plurality of historical performance indicators. In some implementations, the processors can determine the one or more benchmarks by collecting historical performance data from a plurality of entities and modeling, using the one or more AI models, the historical performance data to generate one or more standard performance metrics. Additionally, the processors can determine the one or more performance benchmarks based on the one or more standard performance metrics.

At block 450, the processors (e.g., modeler 116) can apply the modeling dataset and the prompt as input to the one or more AI models to cause the one or more AI models to generate an output regarding one or more performance metrics of the entity (or group of entities, such as a joint venture) to correspond to the one or more performance parameters. In some implementations, the output can include one or more performance product recommendations based on the one or more performance metrics. That is, the performance metrics can be quantitative measures used to evaluate a performance of entity evaluated against the predefined criteria or standards to issue or generate a performance indicator. A performance product recommendation can be a product associated with the performance indicator the provider could provide based on the evaluation of the performance of the company or entity. In some implementations, applying the modeling dataset and the prompt as the input to the one or more AI models can include transforming the plurality of unstructured data items into a plurality of feature vectors. Additionally, applying the modeling dataset can include normalizing the plurality of feature vectors to a scale and inputting the normalized plurality of feature vectors into the one or more AI models to perform predictive and pattern recognition to cause the one or more AI models to generate the output. In some implementations, the processors executing the generative AI model can implement reinforcement learning. The reinforcement learning can include updating the generative AI model based upon receiving feedback on the output and the one or more performance indicators generated from the one or more performance metrics. For example, the feedback can correspond to at least one user interaction with a user interface.

At block 460, the processors (e.g., performance system 118) can generate the one or more performance indicators of the entity based on the one or more performance metrics. In some implementations, the processors can use a performance indicator framework to generate the performance indicator. That is, the framework can be a predefined template or structure to generate the performance indicator that incorporates the various performance metrics. In some implementations, the one or more performance product recommendations can be a performance update including an update to a term or condition of the one or more performance indicators based on the one or more performance metrics. In some implementations, the one or more performance product recommendations can be a product update including a new performance indicator based on the one or more performance metrics At block 470, the processors (e.g., performance system 118) can transmit the one or more performance indicators and the one or more performance product recommendations to a user computing system. In some implementations, the processors can transmit the one or more performance indicators to a user computing system. For example, the user computing system can be operated by a provider or user that initiated the modeling and generating process. In some implementations, the one or more performance indicators can include one or more AI responses annotating the one or more performance indicators for review. That is, the annotations can be notes or comments in or of the performance indicators to facilitate review and approval of the performance indicators (e.g., by an analyst, security reviewer, banker). In some implementations, the AI responses annotating the one or more performance indicators can include metadata annotations corresponding to data provenance (e.g., origin and history the data used), model confidence levels (e.g., prediction confidence of the models output), and/or feature importance scores (e.g., how the data points contributes to the output generated by the AI model). In some implementations, the processors can apply the (i) the modeling dataset, (ii) entity data of the entity, and/or (iii) one or more performance benchmarks as input to one or more AI models to cause one or more AI models to generate an output regarding one or more performance metrics of the entity to correspond to one or more performance parameters. In some implementations, the processors can receive a request from a third-party computing system to re-model the entity. In some implementations, the processors can detect an update of an entry in the one or more data sources to re-model the entity.

The implementations described herein have been described with reference to drawings. The drawings illustrate certain details of specific implementations that implement the systems, methods and programs described herein. However, describing the implementations with drawings should not be construed as imposing on the disclosure any limitations that can be present in the drawings.

It should be understood that no claim element herein is to be construed under the provisions of 35 U.S. C. § 112(f), unless the element is expressly recited using the phrase “means for. ”

As used herein, the term “circuit” can include hardware structured to execute the functions described herein. In some implementations, each respective “circuit” can include software for configuring the hardware to execute the functions described herein. The circuit can be embodied as one or more circuitry components including, but not limited to, processing circuitry, network interfaces, peripheral devices, input devices, output devices, sensors, etc. In some implementations, a circuit can take the form of one or more analog circuits, electronic circuits (e.g., integrated circuits (IC), discrete circuits, system on a chip (SOC) circuits), telecommunication circuits, hybrid circuits, and any other type of “circuit. ” In this regard, the “circuit” can include any type of component for accomplishing or facilitating achievement of the operations described herein. For example, a circuit as described herein can include one or more transistors, logic gates (e.g., NAND, AND, NOR, OR, XOR, NOT, XNOR), resistors, multiplexers, registers, capacitors, inductors, diodes, wiring, and so on.

Accordingly, the “circuit” can also include one or more processors communicatively coupled to one or more memory or memory devices. In this regard, the one or more processors can execute instructions stored in the memory or can execute instructions otherwise accessible to the one or more processors. In some implementations, the one or more processors can be embodied in various ways. The one or more processors can be constructed in a manner sufficient to perform at least the operations described herein. In some implementations, the one or more processors can be shared by multiple circuits (e.g., circuit A and circuit B can include or otherwise share the same processor which, in some example implementations, can execute instructions stored, or otherwise accessed, via different areas of memory). Alternatively or additionally, the one or more processors can be structured to perform or otherwise execute certain operations independent of one or more co-processors. In other example implementations, two or more processors can be coupled via a bus to enable independent, parallel, pipelined, or multi-threaded instruction execution. Each processor can be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors can take the form of a single core processor, multi-core processor (e.g., a dual core processor, triple core processor, quad core processor), microprocessor, etc. In some implementations, the one or more processors can be external to the apparatus, for example the one or more processors can be a remote processor (e.g., a cloud based processor). Alternatively or additionally, the one or more processors can be internal and/or local to the apparatus. In this regard, a given circuit or components thereof can be disposed locally (e.g., as part of a local server, a local computing system) or remotely (e.g., as part of a remote server such as a cloud based server). To that end, a “circuit” as described herein can include components that are distributed across one or more locations.

An exemplary system for implementing the overall system or portions of the implementations might include a general purpose computing devices in the form of computers, including a processing unit, a system memory, and a system bus that couples various system components including the system memory to the processing unit. Each memory device can include non-transient volatile storage media, non-volatile storage media, non-transitory storage media (e.g., one or more volatile and/or non-volatile memories), etc. In some implementations, the non-volatile media can take the form of ROM, flash memory (e.g., flash memory such as NAND, 3D NAND, NOR, 3D NOR), EEPROM, MRAM, magnetic storage, hard discs, optical discs, etc. In other implementations, the volatile storage media can take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device can be operable to maintain or otherwise store information relating to the operations performed by one or more associated circuits, including processor instructions and related data (e.g., database components, object code components, script components), in accordance with the example implementations described herein.

It should also be noted that the term “input devices,” as described herein, can include any type of input device including, but not limited to, a keyboard, a keypad, a mouse, joystick or other input devices performing a similar function. Comparatively, the term “output device,” as described herein, can include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein can show a specific order and composition of method steps, it is understood that the order of these steps can differ from what is depicted. For example, two or more steps can be performed concurrently or with partial concurrence. Also, some method steps that are performed as discrete steps can be combined, steps being performed as a combined step can be separated into discrete steps, the sequence of certain processes can be reversed or otherwise varied, and the nature or number of discrete processes can be altered or varied. The order or sequence of any element or apparatus can be varied or substituted according to alternative implementations. Accordingly, some or all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure can be accomplished with standard programming techniques with rule-based logic and other logic to accomplish the various database searching steps, correlation steps, comparison steps and decision steps.

The foregoing description of implementations has been presented for purposes of illustration and description. It is not intended to be exhaustive or to limit the disclosure to the precise form disclosed, and modifications and variations are possible in light of the above teachings or can be acquired from this disclosure. The implementations were chosen and described in order to explain the principals of the disclosure and its practical application to enable one skilled in the art to utilize the various implementations and with various modifications as are suited to the particular use contemplated. Other substitutions, modifications, changes and omissions can be made in the design, operating conditions and embodiment of the implementations without departing from the scope of the present disclosure as expressed in the appended claims.

What is claimed is:

1. A method for modeling performance of entities using one or more artificial intelligence (AI) models, comprising:
receiving, by one or more processing circuits, an input corresponding to an entity to model;
responsive to the input, accessing, by the one or more processing circuits via one or more data channels, one or more data sources corresponding to the entity;
identifying, by the one or more processing circuits based on the accessing of the one or more data sources via the one or more data channels, a modeling dataset;
generating, by the one or more processing circuits for the one or more AI models, a prompt based on (i) the modeling dataset, (ii) entity data of the entity, and (iii) one or more performance benchmarks, wherein generating the prompt comprises mapping one or more associations corresponding to the modeling dataset and one or more performance parameters of one or more performance indicators;
applying, by the one or more processing circuits, the modeling dataset and the prompt as input to the one or more AI models to cause the one or more AI models to generate an output regarding one or more performance metrics of the entity to correspond to the one or more performance parameters, the output comprising one or more performance product recommendations based on the one or more performance metrics;
generating, by the one or more processing circuits using a performance indicator framework, the one or more performance indicators of the entity based on the one or more performance metrics; and
transmitting, by the one or more processing circuits to a user computing system, the one or more performance indicators and the one or more performance product recommendations, the one or more performance indicators comprises one or more AI responses annotating the one or more performance indicators for review.

2. The method of claim 1, further comprising determining the one or more performance benchmarks by:
collecting, by the one or more processing circuits, historical performance data from a plurality of entities;
modeling, by the one or more processing circuits using the one or more AI models, the historical performance data to generate one or more standard performance metrics; and
determining, by the one or more processing circuits, the one or more performance benchmarks based on the one or more standard performance metrics.

3. The method of claim 1, wherein the one or more AI responses annotating the one or more performance indicators comprise metadata annotations corresponding to data provenance, model confidence levels, and feature importance scores.

4. The method of claim 1, wherein the input is received (i) periodically according to a predefined schedule, (ii) on-demand via a user interface, or (iii) based on a detected event corresponding to the entity.

5. The method of claim 1, further comprising:
receiving, by the one or more processing circuits, a request from a third-party computing system to re-model the entity; or
detecting, by the one or more processing circuits, an update of an entry in the one or more data sources to re-model the entity.

6. The method of claim 1, wherein the one or more performance product recommendations comprise at least one of (i) a performance update comprising an update to a term or condition of the one or more performance indicators based on the one or more performance metrics, or (ii) a product update comprising a new performance indicator based on the one or more performance metrics

7. The method of claim 1, further comprising populating the modeling dataset by:
accessing, by the one or more processing circuits, external data from one or more external computing systems;
accessing, by the one or more processing circuits, internal data from one or more internal computing systems;
wherein the external data comprises at least one of third-party datasets, comparative performance metrics, environmental factors, or demographic information; and
wherein the internal data comprises at least one of proprietary datasets, exchange records, operational data, or internal metrics.

8. The method of claim 1, wherein the modeling dataset comprises a plurality of unstructured data items corresponding to non-relational data generated by the one or more data sources, and wherein applying the modeling dataset and the prompt as the input to the one or more AI models comprises:
transforming, by the one or more processing circuits, the plurality of unstructured data items into a plurality of feature vectors;
normalizing, by the one or more processing circuits, the plurality of feature vectors to a scale; and
inputting, by the one or more processing circuits, the normalized plurality of feature vectors into the one or more AI models to perform predictive and pattern recognition to cause the one or more AI models to generate the output.

9. The method of claim 1, wherein:
the one or more AI models comprise a generative AI model, and wherein the generative AI model comprise at least one of (i) a supervised learning model trained on labeled performance indicators of a plurality of historical performance indicators or (ii) an unsupervised learning model trained on unlabeled performance indicators of the plurality of historical performance indicators; and
the generative AI model implements reinforcement learning;
the reinforcement learning comprises updating the generative AI model based upon receiving feedback on the output and the one or more performance indicators generated from the one or more performance metrics, the feedback corresponding to at least one user interaction with a user interface.

10. A system, comprising:
a data processing system comprising one or more processing circuits configured to:
receive an input corresponding to an entity to model;
responsive to the input, access, via one or more data channels, one or more data sources corresponding to the entity;
identify, based on the accessing of the one or more data sources via one or more data channels, a modeling dataset;
generate, for one or more artificial intelligence (AI) models, a prompt based on (i) the modeling dataset, (ii) entity data of the entity, and (iii) one or more performance benchmarks, wherein generating the prompt comprises mapping one or more associations corresponding to the modeling dataset and one or more performance parameters of one or more performance indicators;
apply the modeling dataset and the prompt as input to the one or more AI models to cause the one or more AI models to generate an output regarding one or more performance metrics of the entity to correspond to the one or more performance parameters, the output comprising one or more performance product recommendations based on the one or more performance metrics;
generate, using a performance indicator framework, the one or more performance indicators of the entity based on the one or more performance metrics; and
transmit, to a user computing system, the one or more performance indicators and the one or more performance product recommendations, the one or more performance indicators comprises one or more AI responses annotating the one or more performance indicators for review.

11. The system of claim 10, further comprising determining the one or more performance benchmarks by:
collecting historical performance data from a plurality of entities;
modeling, using the one or more AI models, the historical performance data to generate one or more standard performance metrics; and
determining the one or more performance benchmarks based on the one or more standard performance metrics.

12. The system of claim 10, wherein the one or more AI responses annotating the one or more performance indicators comprise metadata annotations corresponding to data provenance, model confidence levels, and feature importance scores.

13. The system of claim 10, wherein the input is received (i) periodically according to a predefined schedule, (ii) on-demand via a user interface, or (iii) based on a detected event corresponding to the entity.

14. The system of claim 10, wherein the one or more processing circuits further configured to:
receive a request from a third-party computing system to re-model the entity; or
detect an update of an entry in the one or more data sources to re-model the entity.

15. The system of claim 10, wherein the one or more performance product recommendations comprise at least one of (i) a performance update comprising an update to a term or condition of the one or more performance indicators based on the one or more performance metrics, or (ii) a product update comprising a new performance indicator based on the one or more performance metrics

16. A method for modeling performance of entities using one or more artificial intelligence (AI) models, comprising:
receiving, by one or more processing circuits, an input corresponding to an entity to model;
responsive to the input, accessing, by the one or more processing circuits via one or more data channels, one or more data sources corresponding to the entity;
identifying, by the one or more processing circuits based on the accessing of the one or more data sources via the one or more data channels, a modeling dataset;
applying, by the one or more processing circuits, the (i) the modeling dataset, (ii) entity data of the entity, and (iii) one or more performance benchmarks as input to one or more AI models to cause one or more AI models to generate an output regarding one or more performance metrics of the entity to correspond to one or more performance parameters;
generating, by the one or more processing circuits using a performance indicator framework, one or more performance indicators of the entity based on the one or more performance metrics; and
transmitting, by the one or more processing circuits to a user computing system, the one or more performance indicators comprising one or more AI responses annotating the one or more performance indicators for review.

17. The method of claim 16, further comprising determining the one or more performance benchmarks by:
collecting, by the one or more processing circuits, historical performance data from a plurality of entities;
modeling, by the one or more processing circuits using the one or more AI models, the historical performance data to generate one or more standard performance metrics; and
determining, by the one or more processing circuits, the one or more performance benchmarks based on the one or more standard performance metrics.

18. The method of claim 16, wherein the one or more AI responses annotating the one or more performance indicators comprise metadata annotations corresponding to data provenance, model confidence levels, and feature importance scores.

19. The method of claim 16, wherein the input is received (i) periodically according to a predefined schedule, (ii) on-demand via a user interface, or (iii) based on a detected event corresponding to the entity.

20. The method of claim 16, further comprising:
receiving, by the one or more processing circuits, a request from a third-party computing system to re-model the entity; or
detecting, by the one or more processing circuits, an update of an entry in the one or more data sources to re-model the entity.
